(19) United States
(12) Patent Application Publication
(10) Pub. No.: US 2026/0288287 A1
(43) Pub. Date: Sep. 24, 2026

(54) VIRTUAL ROTARY CONTROL WIDGET ASSOCIATED WITH MULTIPLE CONCENTRIC ANNULAR TOUCH REGIONS OF A TOUCH SENSOR, INCLUDING RELATED APPARATUSES AND METHODS

(71) Applicant: Microchip Touch Solutions Limited, Wokingham (GB)

(72) Inventor: Ian Tocher, Winchester (GB)

(21) Appl. No.: 19/551,992

(22) Filed: Feb. 27, 2026

Related U.S. Application Data
(60) Provisional application No. 63/776,575, filed on Mar. 24, 2025.

(51) Int. Cl. G06F 3/044; G06F 3/041; G06F 3/04847; G06F 3/0488

(52) U.S. Cl. CPC G06F 3/0446; G06F 3/0416; G06F 3/04847; G06F 3/0488

(57) ABSTRACT

An apparatus includes a touch sensor having a virtual rotary control widget. The virtual rotary control widget is associated with multiple concentric annular touch regions on a touch surface of the touch sensor. The multiple concentric annular touch regions include an inner annular touch region and an outer annular touch region. The inner annular touch region is concentric with the outer annular touch region. The inner annular touch region is associated with inner angular position touch detection and response by the touch sensor. The outer annular touch region is associated with outer angular position touch detection and response by the touch sensor. In some examples, an annular isolation region is between and adjacent the inner annular touch region and the outer annular touch region. In other examples, a non-conductive annular finger guide is attached between the inner annular touch region and the outer annular touch region.

### CROSS-REFERENCE TO RELATED APPLICATION

This application claims the benefit under 35 U.S.C. § 119(e) of U.S. Provisional Patent Application Serial No. 63/776,575, filed Mar. 24, 2025, the disclosure of which is hereby incorporated herein in its entirety by this reference.

### TECHNICAL FIELD

Examples relate, generally, to touch sensors. More particularly, some examples relate to virtual control widgets (e.g., including graphical and/or tangible control widgets) of a touch sensor. Additionally, related methods and apparatuses are disclosed.

### BACKGROUND

A typical touch interface system may incorporate touch sensors (e.g., capacitive sensors and/or resistive sensors, without limitation) that respond to an object in close proximity to, or physical contact with, a contact sensitive surface of a touch interface system. Such responses may be captured and interpreted to infer information about the contact, including a location of an object relative to the touch interface system. Touchpads used with personal computers, including laptop computers and keyboards for tablets, often incorporate or operate in conjunction with a touch interface system.

Displays often include touchscreens that incorporate elements (e.g., at least a touch sensor) of a touch interface system to enable a user to interact with a graphical user interface (GUI) and/or computer applications. Examples of devices that incorporate a touch display include portable media players, televisions, smart phones, tablet computers, personal computers, and wearables such as smart watches, just to name a few. Further, control panels for automobiles, appliances (e.g., an oven, refrigerator or laundry machine) security systems, automatic teller machines (ATMs), residential environmental control systems, and industrial equipment may incorporate touch interface systems with displays and housings, including to enable buttons, sliders, wheels, and other touch elements.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a front perspective view of a system including a touchscreen device having a touchscreen;

FIG. 2A is a schematic diagram of a capacitive touch system including a touch sensor for the touchscreen of FIG. 1;

FIG. 2B is a schematic diagram of a touch controller of the touch sensor of FIG. 2A;

FIG. 3A is a top-down view of a multi-layer arrangement of the touch sensor;

FIG. 3B is a cross-sectional view of the multi-layer arrangement of the touch sensor of FIG. 3A;

FIG. 4 is a schematic diagram of an apparatus including the capacitive touch system having the touch sensor and the touch controller;

FIG. 5A is a perspective view of a system including a touchscreen device having a touchscreen that implements a virtual rotary control widget, according to one or more examples of the disclosure;

FIG. 5B is a front view of the virtual rotary control widget of FIG. 5A, according to one or more examples;

FIG. 5C is a side or cross-sectional view of the virtual rotary control widget of FIGS. 5A and 5B, according to one or more examples;

FIG. 5D is a side or cross-sectional view of the virtual rotary control widget of FIGS. 5A and 5B together with recessed finger-guiding tracks, according to one or more examples;

FIG. 6A is a front view of a virtual rotary control widget including an annular finger guide, according to one or more examples;

FIG. 6B is a side or cross-sectional view of the virtual rotary control widget of FIG. 6A, according to one or more examples;

FIG. 7 is a flowchart of a method of touch signal processing for a virtual rotary control widget of a touch sensor, according to one or more examples of the disclosure;

FIG. 8 is a front perspective view of a system including a touchscreen that implements the virtual rotary control widget with the annular finger guide of FIG. 6A;

FIGS. 9A and 9B are left-front perspective views of the virtual rotary control widget with the annular finger guide of FIG. 8;

FIG. 9C is a front view of the virtual rotary control widget of FIG. 8 for discrete angular position detection, according to one or more examples;

FIG. 10 is a front view of the virtual rotary control widget 601 for discrete angular position detection, according to one or more examples;

FIG. 11A includes a front view and a side or cross-sectional view of a virtual rotary control widget, according to one or more alternative examples;

FIG. 11B includes a front view and a side or cross-sectional view of the virtual rotary control widget of FIG. 11A, according to one or more alternative examples;

FIG. 12 is a perspective view of a system including the touchscreen device of FIG. 5A operative with a knob-on-display (KoD) device, according to one or more examples;

FIGS. 13A and 13B are respective frontal views of the KoD device of FIG. 12, according to one or more examples;

FIG. 14 is a cross-sectional view of the KoD device of FIGS. 12, 13A, and 13B, according to one or more examples;

FIG. 15 is a visual presentation of an audio system on a touchscreen implementing one or more virtual rotary control widgets, according to one or more examples; and

FIG. 16 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples in which the disclosure may be practiced. These examples are described in sufficient detail to enable a person of ordinary skill in the art to practice the disclosure. However, other examples enabled herein may be utilized, and structural, material, and process changes may be made without departing from the scope of the disclosure.

The illustrations presented herein are not meant to be actual views of any particular method, system, device, or structure, but are merely idealized representations that are employed to describe the examples of the disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, steps, features, functions, or the like.

It will be readily understood that the components of the examples as generally described herein and illustrated in the drawings could be arranged and designed in a wide variety of different configurations. Thus, the following description of various examples is not intended to limit the scope of the disclosure, but is merely representative of various examples. While the various aspects of the examples may be presented in the drawings, the drawings are not necessarily drawn to scale unless specifically indicated. Throughout the figures, some features are the same as or similar to other features in previously-presented figures, as indicated by the same reference numbers, unless expressly described otherwise.

Furthermore, specific implementations shown and described are only examples and should not be construed as the only way to implement the disclosure unless specified otherwise herein. Elements, circuits, and functions may be shown in block diagram form in order not to obscure the disclosure in unnecessary detail. Conversely, specific implementations shown and described are exemplary only and should not be construed as the only way to implement the disclosure unless specified otherwise herein. Additionally, block definitions and partitioning of logic between various blocks is exemplary of a specific implementation. It will be readily apparent to one of ordinary skill in the art that the disclosure may be practiced by numerous other partitioning solutions. For the most part, details concerning timing considerations and the like have been omitted where such details are not necessary to obtain a complete understanding of the disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the disclosure may be implemented on any number of data signals including a single data signal.

The various illustrative logical blocks, modules, and circuits described in connection with the examples disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general‑purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is to execute computing instructions (e.g., software code) related to examples of the disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements. As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Touch sensors, such as capacitive touch sensors, enable detection of user touch input on a touch surface and may be integrated into infotainment systems, instrument panels, and other display-based interfaces. Such touch sensors can implement virtual control widgets which allow users to control functions through touch interaction while reducing the number of discrete mechanical controls. Virtual control widgets can improve packaging flexibility, reduce manufacturing complexity, and provide configurable user interfaces that adapt to different modes or user preferences. As touch surfaces may provide limited tactile feedback, however, tactile or physical components such as overlays, finger guides, raised textures, or knob-on-display (KoD) devices may be used to guide user interaction and improve ease of use, particularly in situations where the user’s attention may be divided, such as during operation of a vehicle.

According to one or more examples, a virtual rotary control widget of a touch sensor is described herein. The virtual rotary control widget is adapted to provide virtual concentric rotary controls for an application, with two or more related controls being grouped together in a concentric arrangement. In one or more examples, the virtual rotary control widget provides for both inner rotary touch control and outer rotary touch control – a dual rotary control functionality. In one or more examples, the virtual rotary control widget is provided with a software-switching mechanism to unlock and lock the dual rotary control functionality, so that the inner and outer rotary touch controls can function independently from each other or function in tandem with each other.

More particularly, in one or more examples, the virtual rotary control widget is associated with multiple concentric annular touch regions on a touch surface of the touch sensor. The multiple concentric annular touch regions include an inner annular touch region and an outer annular touch region. The inner annular touch region is concentric with the outer annular touch region. The inner annular touch region is associated with inner angular position touch detection and response by the touch sensor. The outer annular touch region is associated with outer angular position touch detection and response by the touch sensor.

In one or more examples, the virtual rotary control widget is associated with an annular isolation region between and adjacent the inner annular touch region and the outer annular touch region. The annular isolation region is without position touch detection and/or response by the touch sensor.

In one or more other examples, a non-conductive annular finger guide is attached between the inner annular touch region and the outer annular touch region.

In one or more other further examples, an inner recessed finger-guiding track is formed substantially within the inner annular touch region, and an outer recessed finger-guiding track is formed substantially within the outer annular touch region.

In one or more accessory-type examples, knob-on-display (KoD) device may be adapted for use with the virtual rotary control widget. The KoD device is to mount on a touch surface over the virtual rotary control widget, to offer the user physical control via a rotary knob – i.e., a dual concentric rotary knob – together with touch sensing using conductive pads at a bottom of the KoD device.

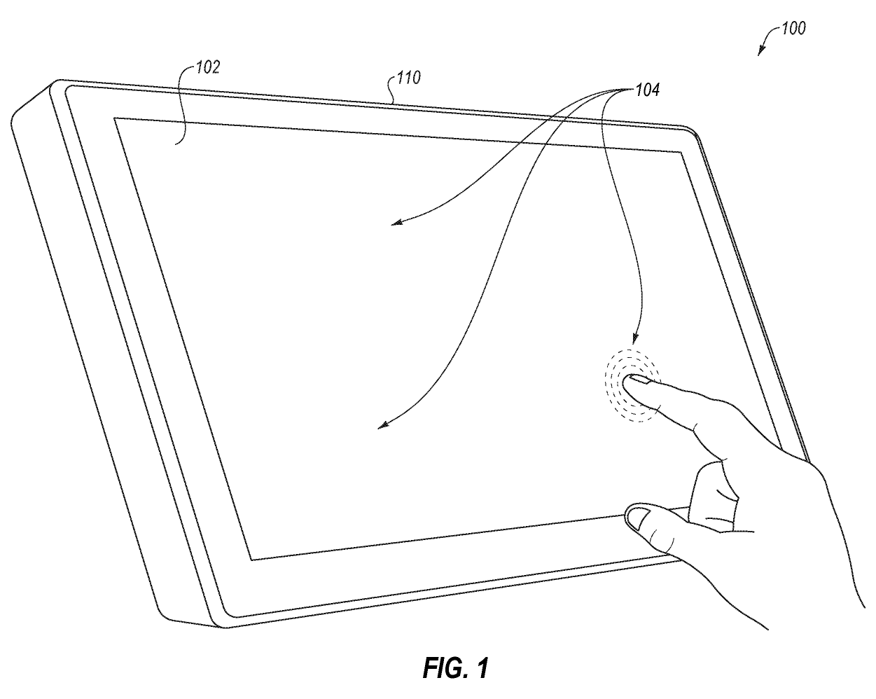

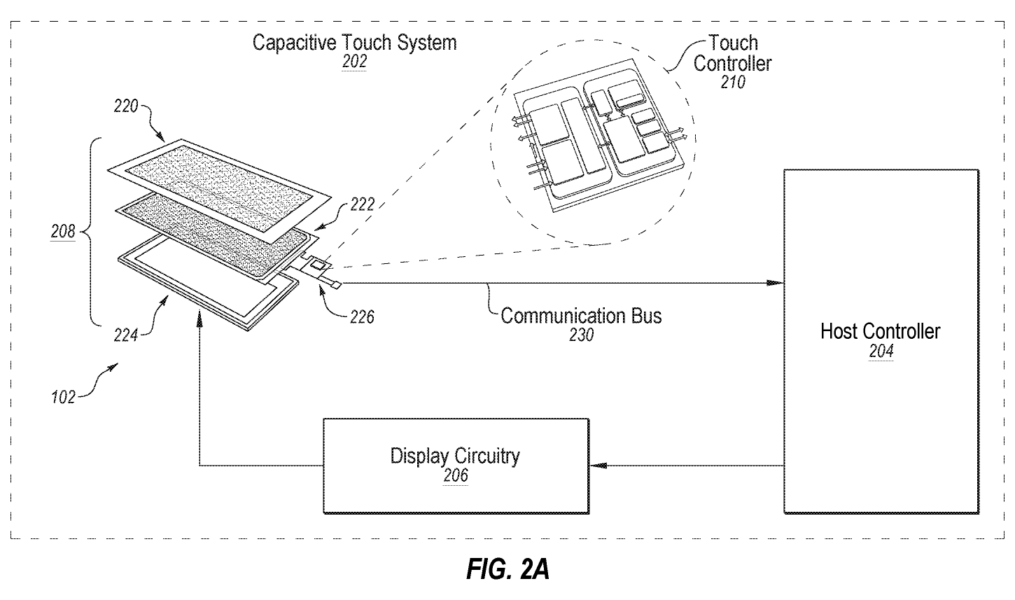

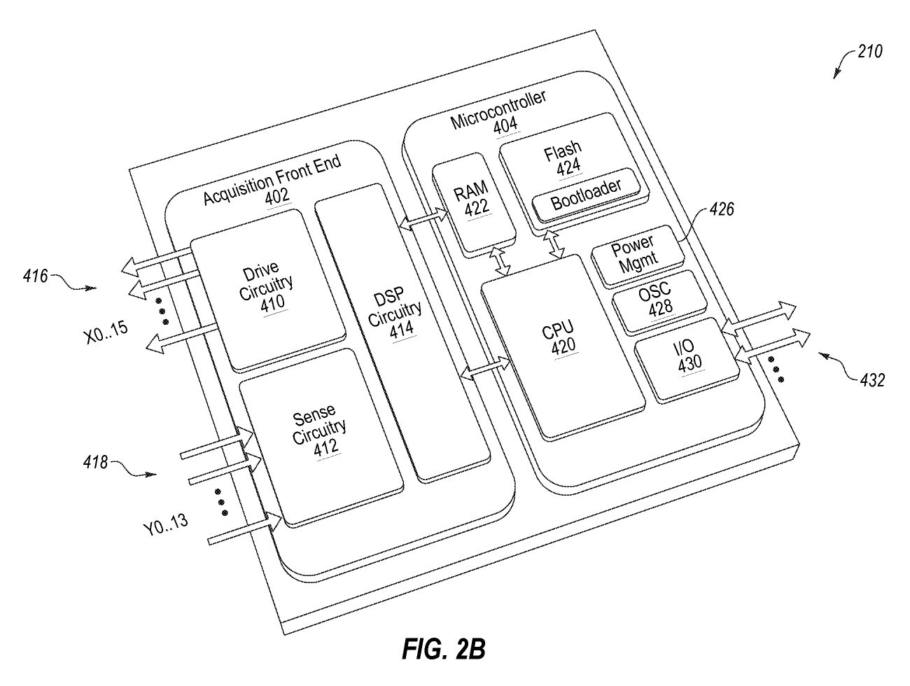

FIG. 1 is a front perspective view of a system 100 including a touchscreen device 110 having a touchscreen 102. In one or more examples, touchscreen 102 may utilize a capacitive touch system for capacitive touch-sensing operations (e.g., a capacitive touch system 202 of FIG. 2 to be discussed below).

In general, the capacitive touch system of touchscreen device 110 of FIG. 1 operates by detecting electrical properties of a conductive object (e.g., a human fingertip) to determine touch input within a capacitive touch-sensitive area 104. Touchscreen 102 typically includes layers coated with a transparent conductive material, such as Indium Tin Oxide (ITO). The transparent conductive material holds a small electrical charge distributed across a grid of touch-sensing regions within capacitive touch-sensitive area 104. With the help of a touch controller, each of these sensing regions contains multiple touch points that regularly measure changes in capacitance. When a user’s fingertip (or other object) comes into contact with the touchscreen 102 at a touch location, it disturbs the electrostatic field at specific touch points within the sensing regions. Signals from the sensing regions are provided to the touch controller that calculates precise coordinates of the touch location. A host controller of the capacitive touch system interprets the coordinates of the touch location as a command, such as a tap, a swipe, or a pinch, and may invoke a function in response to the command.

Capacitive touchscreens are highly accurate, durable, and multi-touch capable, and are therefore widely used across many industries. Thus, touchscreen device 110 may be one of any number of different types of devices. As examples, touchscreen device 110 may be or be part of an automotive display device (e.g., in an SDV display, as an infotainment system or in-vehicle infotainment (IVI) system), a personal computer (PC), an all-in-one PC, a laptop, a tablet, a 2-in-1 hybrid device (e.g., laptop/tablet), a smartphone, a point-of-sale (PoS) terminal, a gaming device, a smart home device (e.g., to monitor, control, and/or manage lighting, temperature, security, entertainment, and household appliances), a factory control panel device (e.g., to monitor, control, and/or manage machinery or processes), or a medical device (e.g., to monitor, control, and/or manage patient monitoring systems, ultrasound machines, infusion pumps, electronic medical record (EMR) terminals, or diagnostic imaging devices), to name but a few.

FIG. 2A is a schematic diagram of a capacitive touch system 202 including a capacitive touch sensor 222 (hereinafter, a “touch sensor 222”) for a touchscreen. In one or more examples, capacitive touch system 202 is part of a touchscreen device, such as touchscreen device 110 of FIG. 1. Capacitive touch system 202 includes touchscreen 102, a display circuitry 206, and a host controller 204. In general, touchscreen 102 comprises a multi-layered input/output (I/O) device 208 including a touch controller 210. Multi-layered I/O device 208 comprises one or more layers of a front panel 220, one or more layers of touch sensor 222, and one or more layers of a display 224. Typically, in multi-layered I/O device 208, front panel 220 is overlaid on top of touch sensor 222, which is overlaid on top of display 224.

In one or more examples of FIG. 2A, touch controller 210 is mounted on and electrically connected to a flexible cable 226, and shown in an enlarged view in a magnifying circular window for better clarity. Multi-layered I/O device 208 of touchscreen 102 is operably coupled to touch controller 210 via flexible cable 226. In particular, touch sensor 222 is operably coupled to touch controller 210 for capacitive touch detection. Touch controller 210 is further coupled to host controller 204 via a communication bus 230 via flexible cable 226. Communication bus 230 may be any suitable type of communication bus, such as an Inter-Integrated Circuit (I2C) bus, a Universal Serial Bus (USB), or a Serial Peripheral Interface (SPI) bus, without limitation. Display 224 is operably coupled to display circuitry 206, which is operably coupled to host controller 204. Display 224 may be any suitable type of display, such as a liquid crystal display (LCD), an Organic Light-Emitting Diode (OLED) display, or an Active Matrix Organic Light Emitting Diode (AMOLED) display, without limitation.

Touch controller 210 includes (e.g., dedicated) processing circuitry for processing signals of touch sensor 222 of multi-layered I/O device 208. For example, touch controller 210 is to receive raw signals associated with any capacitance changes at touch sensor 222 (i.e., from user touches), process the raw signals to determine location(s) and/or state(s) of any detected touch inputs, and translate that data into detected touch position data (e.g., detected x-y touch coordinates). Touch controller 210 communicates the detected touch position data (e.g., detected x-y touch coordinates) to host controller 204 over communication bus 230. Host controller 204 may receive and respond to the detected touch position data by performing operations or functions associated with the detected touch position data.

Host controller 204 is considered to be the main or primary controller of the device, and therefore operates to control one or more main or primary operations of the device. Main or primary operations of the device may include performing functions associated with application-specific processing of the device (e.g., functions typically associated with the application or the type of device, whether it be an automotive display device, a PC, a laptop, a tablet, a 2-in-1 hybrid device, a smartphone, a PoS terminal, a gaming device, a smart home device, a factory control panel device, a medical device, and so on). Host controller 204 receives detected touch position data via touch sensor 222, and in response, communicates signals to display circuitry 206 to display information in display 224 and performs the application-specific functions associated with the detected touch position.

FIG. 2B is a schematic diagram of touch controller 210 of touch sensor 222 of FIG. 2A. In one or more examples, touch controller 210 of FIG. 2B includes an acquisition front end 402 and a microcontroller 404. Acquisition front end 402 includes a drive circuitry 410, a sense circuitry 412, and a digital signal processing (DSP) circuitry 414 (e.g., a DSP processing and control circuitry). Microcontroller 404 includes a central processing unit (CPU) 420, an oscillator 428, an I/O interface circuitry 430 for one or more communication buses 432, and a power management module 426. One or more clock signals may be generated from oscillator 428 and used for timing of circuitry (e.g., CPU 420, DSP circuitry 414, and so on). Microcontroller 404 also includes memory, including RAM 422 and flash memory 424 (e.g., including a bootloader process). In one or more examples, an application may be stored in flash memory 424 to control operation of CPU 420 and/or DSP circuitry 414.

In one or more examples, all or most of the components of touch controller 210 are provided in IC, such as a touch controller IC, for use in a computing device or terminal (e.g., touchscreen device 110 of FIG. 1). In one or more examples, touch controller 210 is configured with a circuit design based on a maXTouch® touch controller. maXTouch® is a registered trademark of Microchip Technology Incorporated, of Chandler, Arizona, USA.

In one or more examples, touch controller 210 includes acquisition front end 402 for processing signals of a capacitive touch sensor. Here, DSP circuitry 414 is operably coupled to drive circuitry 410, and drive circuitry 410 is coupled to a number of drive lines 416. In one or more examples, drive circuitry 410 is referred to as transmit (Tx) circuitry and the number of drive lines 416 is referred to as a number of transmit lines. In one or more examples of FIG. 2B, the number of drive lines 416 includes sixteen (16) drive lines, which are designated in the figure as X0 through X15. DSP circuitry 414 is also operably coupled to sense circuitry 412, and sense circuitry 412 is coupled to a number of sense lines 418. In one or more examples, sense circuitry 412 is referred to as receive (Rx) circuitry and the number of sense lines 418 is referred to as a number of receive lines. In one or more examples of FIG. 2B, the number of sense lines 418 includes fourteen (14) sense lines, which are designated in the figure as Y0 through Y13. In one or more examples, the number of drive lines 416 are provided as output pins of the touch controller IC, and the number of sense lines 418 are provided as input pins of the touch controller IC. In one or more examples, I/O interface circuitry 430 may be coupled to output pins (e.g., provided with one or more connectors).

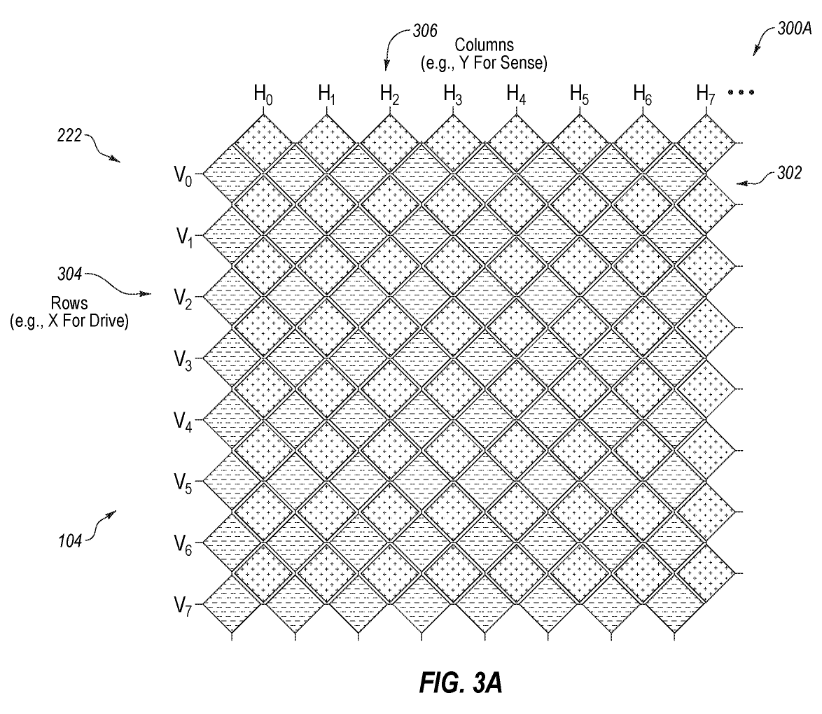

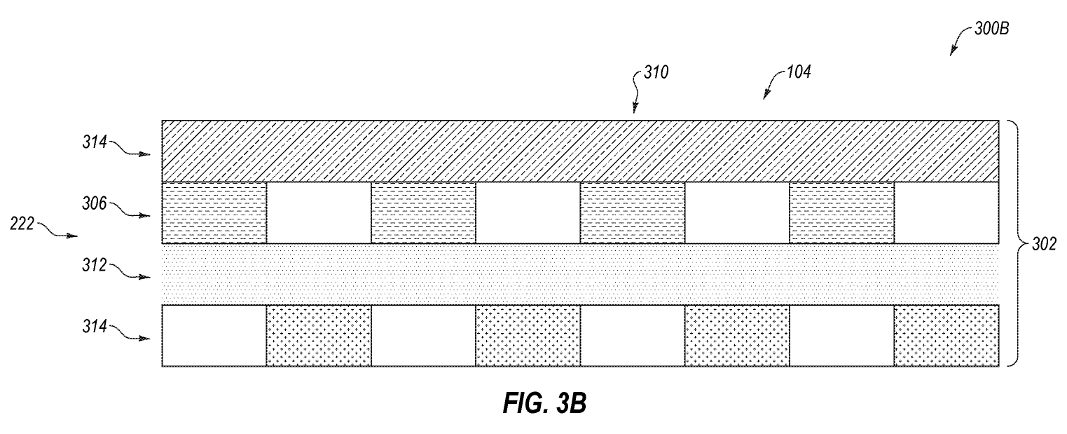

FIG. 3A is a top-down view 300A of a multi-layer arrangement 302 of touch sensor 222. FIG. 3B is a cross-sectional view 300B of multi-layer arrangement 302 of touch sensor 222 of FIG. 3A.

Touch sensor 222 of FIGS. 3A and 3B is adapted for mutual capacitance touch detection. With reference to FIG. 3A, multi-layer arrangement 302 of touch sensor 222 includes a drive electrode layer 304 including drive electrodes (e.g., indicated by horizontal hatching, or single-line or linear hatching, in FIG. 3A) and a sense electrode layer 306 including sense electrodes (e.g., indicated by grid hatching, or cross or plus hatching, in FIG. 3A). In FIG. 3B, it is shown that sense electrode layer 306 is stacked over drive electrode layer 304, separated by an adhesive layer 312, and covered with a protective layer 314 (e.g., Perspex or glass). Adhesive layer 312 is typically relatively firm or inflexible, as any physical movement of sense electrode layer 306 relative to drive electrode layer 304 would cause undesirable changes in capacitance.

In the stacked arrangement, drive electrode layer 304 including the drive electrodes and sense electrode layer 306 including the sense electrodes are arranged in an array of interacting electrodes comprising capacitive nodes (e.g., mutual capacitance nodes) at which changes in capacitance are sensed. In one or more examples, the horizontally-connected electrodes of drive electrode layer 304 (e.g., rows, driven by “X” or drive lines) correspond to changes that vary vertically (e.g., V0 through V7) to help determine the Y position. The vertically-connected electrodes of sense electrode layer 306 (e.g., columns, sensed at “Y” or sense lines) correspond to changes that vary horizontally (e.g., H0 through H7) to help determine the X position.

In contemplated operation with respect to capacitive touch-sensitive area 104, the touch controller is used to sequentially excite respective drive lines (e.g., X lines) with an AC voltage. At each capacitive node (e.g., intersection of an X-line and Y-line) a small mutual capacitance (Cₘ) is formed. When a finger touches at or near a node (e.g., a touch 310 of FIG. 3B), it disturbs the electric field, reducing Cₘ at that point (e.g., part of the electric field couples to the human body). A capacitive coupling strength at each intersection may be detected at respective sense lines (e.g., Y lines). By scanning all intersections, the touch controller can map the exact touch location.

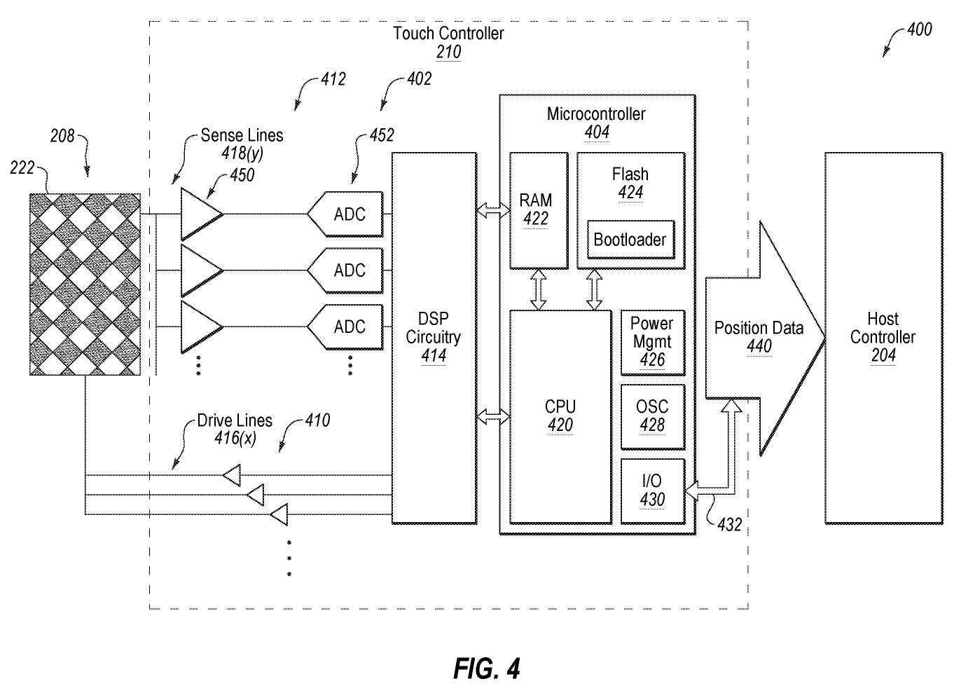

FIG. 4 is a schematic diagram of an apparatus 400 including the capacitive touch system having touch sensor 222 and touch controller 210, according to one or more examples. Some of the features in FIG. 4 are the same as or similar to some of the features in FIGS. 2A and 2B, as indicated by the same reference numbers, unless expressly described otherwise. In one or more examples, apparatus 400 of FIG. 4 may be part of the touchscreen device 110 of FIG. 1. The capacitive touch system of apparatus 400 of FIG. 4 may include some of the basic components of capacitive touch system 202 of FIG. 2A, including the touchscreen (e.g., multi-layered I/O device 208 including at least touch sensor 222), the display circuitry (e.g., display circuitry 206 of FIG. 2A), and host controller 204.

In one or more examples, touch controller 210 of FIG. 4 includes acquisition front end 402 for processing signals of touch sensor 222 for touch detection. In one or more examples, touch sensor 222 may include an array or grid of electrodes arranged in rows and columns (e.g., drive and sense electrodes in FIGS. 3A and 3B). Each intersection point between a row and a column of electrodes form a (capacitive) sensor node. The electrodes may be divided into two sets; a first set coupled to the number of drive lines 416 (e.g., rows or x-lines) of touch controller 210 and a second set coupled to the number of sense lines 418 (e.g., columns or y-lines) of touch controller 210. In one or more examples, drive circuitry 410 may be connected to the rows or x-lines (e.g., X0 – X15 for rows 1-15), and sense circuitry 412 may be connected to the columns or y-lines (e.g., Y0 – Y13 for columns 1-13).

In one or more examples, drive circuitry 410 includes a number of driver circuits respectively associated with the number of drive lines 416. In one or more examples, sense circuitry 412 includes a number of buffer circuits 450 (or, alternatively, for example, driver amplifier circuits or transimpedance amplifier circuits) and a number of analog-to-digital converters (ADCs) 452. The number of buffer circuits 450 is respectively associated with the number of sense lines 418. The number of buffer circuits 450 is respectively coupled to the number of ADCs 452, which are respectively coupled to inputs of DSP circuitry 414.

In contemplated operation, touch controller 210 may drive an electrical signal (or a “drive signal”) at each row of a sense electrode of touch sensor 222, e.g., sequentially, via the number of drive lines 416 using drive circuitry 410. The drive signal may be any suitable electrical signal, frequency signal, square wave, series of bursts or pulses, alternating voltage or current signals, and so on. Sense circuitry 412 may measure a mutual capacitance as a voltage at each column of a sense electrode of touch sensor 222, e.g., sequentially, via the number of sense lines 418. Based on the measurements, DSP circuitry 414 may detect changes in capacitance/voltage to detect a location of a touch.

When a conductive object, such as a finger, approaches the touchscreen and makes contact with the surface thereof, the finger may form a capacitive coupling between drive and sense electrodes at the point of touch, thereby altering (e.g., lowering) the capacitance at the corresponding intersection point(s). The sense lines may measure the capacitance as a voltage at each of the sense electrodes. Changes in capacitance/voltage (e.g., indicating a decrease in capacitance/voltage) may be analyzed by DSP circuitry 414 to determine touch position data (e.g., the location of the touch), which may be communicated to CPU 420 and/or RAM 422 of microcontroller 404. In one or more examples, microcontroller 404 uses I/O interface circuitry 430 to communicate, at a communication process 440 (“Position Data”), the detected touch position data to host controller 204 via communication bus 432.

In one or more examples, operation of the virtual rotary control widget, as described herein in further detail, is implemented by software or processor-executable instructions stored in on-chip nonvolatile memory of touch controller 210, such as embedded Flash memory (e.g., Flash 424), ROM, or mask ROM (e.g., fixed firmware). In one or more examples, configuration parameters for operation of the virtual rotary control widget are stored in nonvolatile memory, such as EEPROM. In one or more examples, touch controller 210 translates x-y coordinate position data into angular touch position data (e.g., inner angular touch position and outer angular touch position, whether values, indicators, etc.) according to the configuration parameters, and communicates the angular touch position data as position data in communication process 440. In one or more specific examples, operation of the virtual rotary control widget is enabled for a user or designer through user instructions and/or configuration software for programming configuration parameters of the widget (e.g., a configuration utility provided to the user or designer to configure operation of the touchscreen, including the virtual rotary control widget).

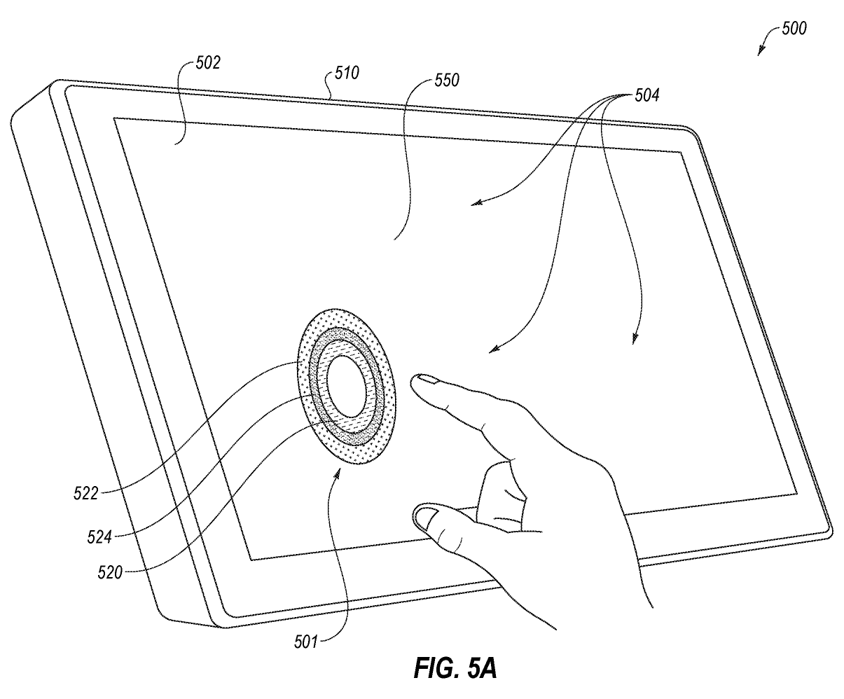

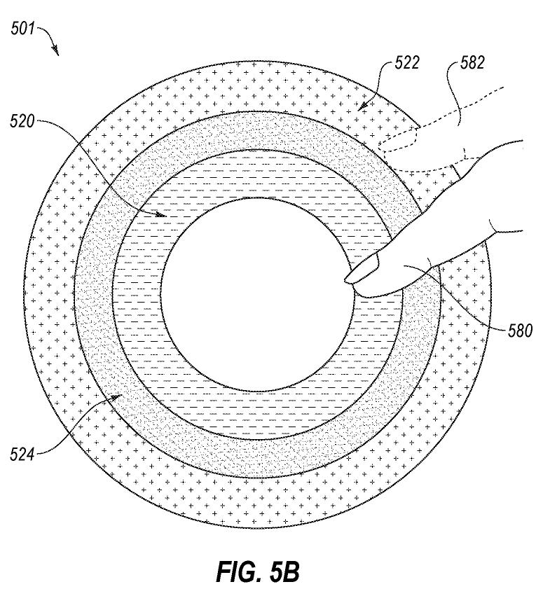

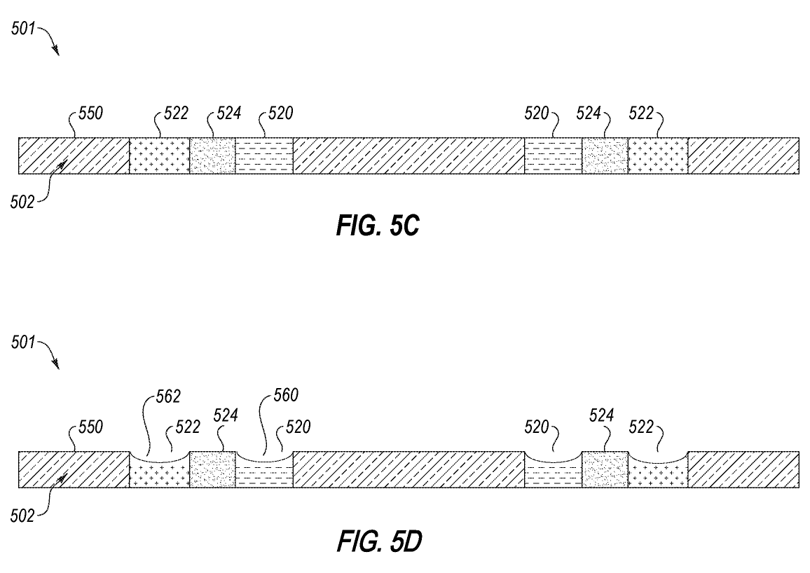

FIG. 5A is a perspective view of a system 500 including a touchscreen device 510 having a touchscreen 502 that implements a virtual rotary control widget 501, according to one or more examples. FIG. 5B is a front view of virtual rotary control widget 501 of FIG. 5A, according to one or more examples. FIG. 5C is a side or cross-sectional view of virtual rotary control widget 501 of FIGS. 5A and 5B, according to one or more examples.

Like touchscreen 102 of FIG. 1, touchscreen 502 of FIG. 5A may utilize a capacitive touch system for capacitive touch-sensing operations (e.g., capacitive touch system 202 of FIG. 2). In general, the capacitive touch system of touchscreen device 510 operates by detecting electrical properties of a conductive object (e.g., a human fingertip) to determine touch input within a capacitive touch-sensitive area 504. The transparent conductive material holds a small electrical charge distributed across a grid of touch-sensing regions within capacitive touch-sensitive area 504. With the help of the touch controller, each of these sensing regions contains multiple touch points that regularly measure changes in capacitance. When a user’s fingertip or other object comes into contact with touchscreen 502 at a touch location, it disturbs the electrostatic field at specific touch points within the sensing regions. Signals from the sensing regions are provided to the touch controller that calculates precise touch coordinates (e.g., x-y touch coordinate data) of the touch location.

In general, virtual rotary control widget 501 is adapted to detect rotational touch input from a finger and/or a rotary knob, according to one or more examples. Virtual rotary control widget 501 is associated with multiple concentric annular touch regions on a touch surface 550 of a touch sensor (e.g., touch sensor 222 of FIG. 2A). The concentric annular touch regions of virtual rotary control widget 501 include an inner annular touch region 520 and an outer annular touch region 522. Inner annular touch region 520 is concentric with outer annular touch region 522.

In one or more examples, inner annular touch region 520 of virtual rotary control widget 501 is associated with inner angular position touch detection and response by the touch sensor. Outer annular touch region 522 of virtual rotary control widget 501 is associated with outer angular position touch detection and response by the touch sensor.

In one or more examples, the rotational touch input to virtual rotary control widget 501 may involve circumferential finger movement along the widget. As one example, a finger-based touch input 580 of FIG. 5B may involve circumferential finger movement along or around inner annular touch region 520. The touch controller of the touch sensor (e.g., touch controller 210 of FIG. 2A) may provide the inner angular position touch detection and response related to inner annular touch region 520. When touch coordinates (e.g., x-y touch coordinate data) are detected to be within inner annular touch region 520 (e.g., in response to finger-based touch input 580 of FIG. 5B), the touch controller translates the touch coordinates into an inner angular touch position. The touch controller may communicate the inner angular touch position to the host controller. In response, the host controller may interpret the inner angular touch position as a command (e.g., a first command associated with inner annular touch region 520, with the inner angular touch position as an input parameter to the first command), and also invoke a function in response to the command.

As another example, a finger-based touch input 582 of FIG. 5B may involve circumferential finger movement along or around outer annular touch region 522. The touch controller of the touch sensor (e.g., touch controller 210 of FIG. 2A) may provide the outer angular position touch detection and response related to outer annular touch region 522. When the touch coordinates (e.g., x-y touch coordinate data) are detected to be within outer annular touch region 522 (e.g., in response to finger-based touch input 582 of FIG. 5B), the touch controller translates the touch coordinates into an outer angular touch position. The touch controller may communicate the inner angular touch position to the host controller. In response, the host controller may interpret the outer angular touch position as another command (e.g., a second command associated with outer annular touch region 522, with the outer angular touch position as an input parameter to the second command), and also invoke another function in response to the other command.

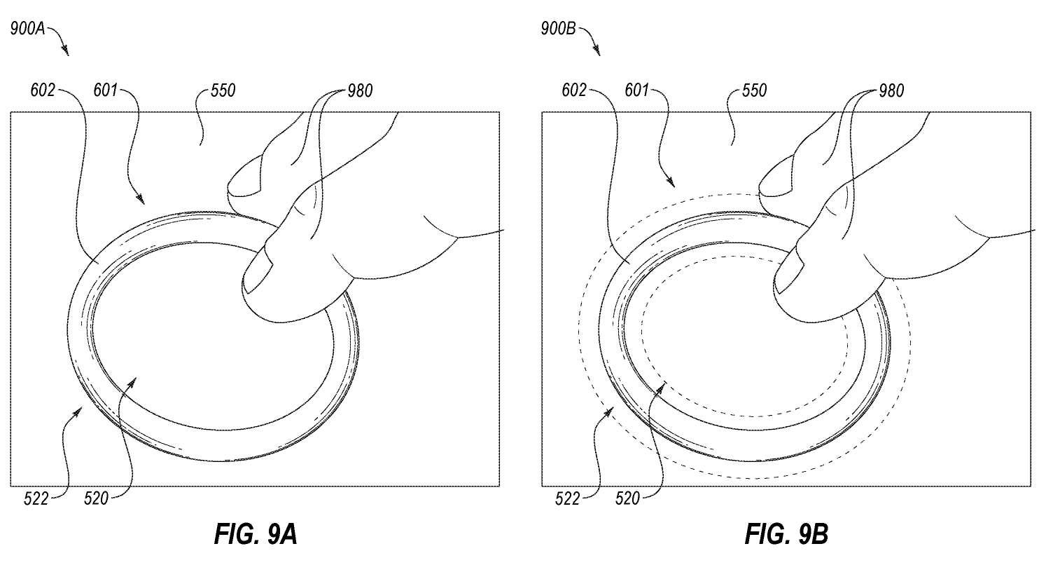

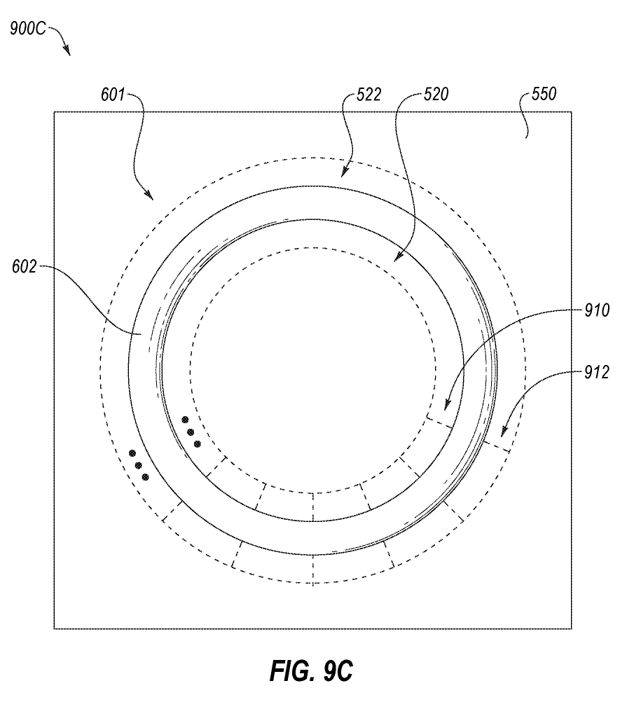

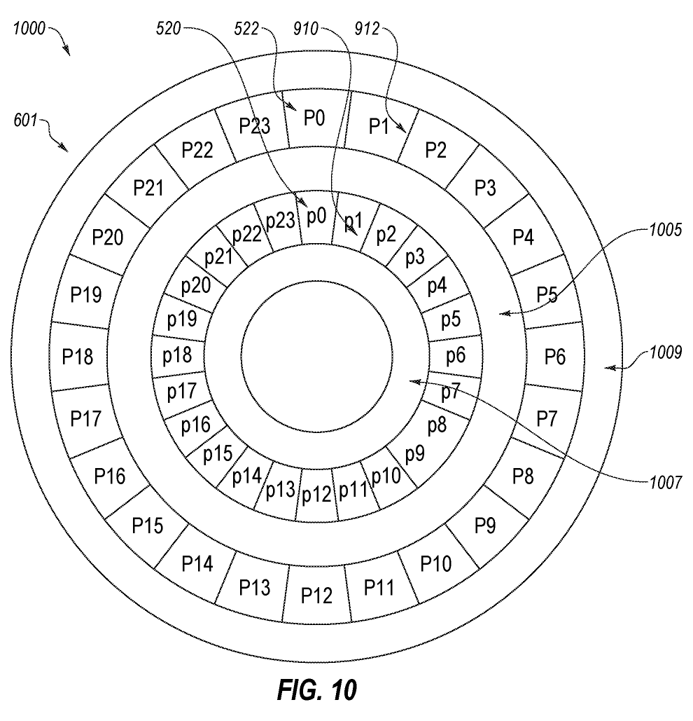

In one or more examples, the touch control detects the touch position (e.g., x-y touch coordinate data) and computes an angular position corresponding to the touch position relative to a defined center point of virtual rotary control widget 501. In one or more examples, the touch controller computes a substantially continuous angular position at least partially based on the detected touch position. Here, in a specific, non-limiting example, the touch controller computes the substantially continuous angular position based on determining an offset of the detected x-y touch coordinate data (e.g., x and y offset components) from the defined center point and applying an arctangent function (e.g., arctan2) to the offset. In one or more other specific examples, the touch controller selects one of a number of discrete angular positions (e.g., angular indexes) corresponding to an identified one of a number of predefined arc regions (e.g., angular bins) within which the detected touch coordinate(s) is located (e.g., discussed later in relation to FIG. 9C and 10).

In one or more examples, virtual rotary control widget 501 is further associated with an annular region 524 between and adjacent inner annular touch region 520 and outer annular touch region 522. Annular region 524 is concentric with inner annular touch region 520 and outer annular touch region 522. In one or more examples, annular region 524 may be an annular isolation region. In one or more examples, an annular isolation region is without position touch detection and/or response by the touch sensor. Thus, the annular isolation region can prevent touches within inner annular touch region 520 and outer annular touch region 522 from interfering with each other. Here, the touch controller of the touch sensor may ignore or discard detected x-y touch coordinate data within annular region 524, or translate detected x-y touch coordinate data into an angular position but refrain from sending the angular position to the host controller, as some examples. In one or more examples, the touch sensor is to perform (e.g., standard, non-angular) touch position detection and response outside of the concentric annular touch regions of virtual rotary control widget 501 (e.g., outside of outer annular touch region 522).

Virtual rotary control widget 501 and/or its concentric annular touch regions are sized to accommodate a fingertip contact area associated with a user. In a specific, non-limiting example, the diameter of virtual rotary control widget 501 is between about 60-100 millimeters (mm). In one or more examples, a mean diameter of outer annular touch region 522 is greater than the mean diameter of inner annular touch region 520. In a specific, non-limiting example, the mean diameter of inner annular touch region 520 is between about 30-50 mm, and the mean diameter of outer annular touch region 522 is between about 55-80 mm. The mean diameter of an annular touch region is considered to be the difference between outer and inner diameters of the annular touch region.

In one or more examples, a radial thickness of inner annular touch region 520 is substantially the same as the radial thickness of outer annular touch region 522. In a specific, non-limiting example, the radial thickness of inner annular touch region 520 is between about 5-10 mm, and the radial thickness of outer annular touch region 522 is also between about 5-10 mm. In one or more further examples, the radial thickness of annular region 524 is substantially the same as, or (e.g., slightly) less than, the radial thickness of inner annular touch region 520 or outer annular touch region 522. In a specific, non-limiting example, the radial thickness of annular region 524 is between about 4-8 mm. The radial thickness of an annular touch region is considered to be the width or the radial width of the annular touch region.

In one or more examples, virtual rotary control widget 501 includes visual indicia that are rendered in the display. In one or more examples, the visual indicia include one or more of coloring, marking, visual texturing, and so on, within and/or around one or more of the concentric annular touch regions of virtual rotary control widget 501. As one example, the visual indicia are rendered within and/or around inner annular touch region 520 and outer annular touch region 522. As another example, the visual indicia are rendered within and/or around (e.g., only) annular region 524. As yet another example, the visual indicia are rendered within and/or around inner annular touch region 520, outer annular touch region 522, and annular region 524. In one or more other examples, virtual rotary control widget 501 has little or no visual indicia rendered within and/or around the concentric annular touch regions (e.g., rather, one or more finger guides, such as an annular finger guide, may be used). In one or more examples, an inner angular position visual indicator is presented at a current angular position setting within inner annular touch region 520 (e.g., maintained during and/or after release of the user’s touch), and an outer angular position visual indicator is presented at a current angular position setting within outer annular touch region 522 (e.g., maintained during and/or after release of the user’s touch).

In one or more examples, virtual rotary control widget 501 has rotary controls associated with or assigned to functionalities that are context-dependent or application-dependent (e.g., set or enabled “on-the-fly” responsive to context or application). Such operation and/or function assignment may be provided through processing of the touch controller, the host controller, or both the touch controller and the host controller. For a first application selected at the touchscreen device, virtual rotary control widget 501 is enabled (e.g., configured) with rotary controls associated with functionalities of the first application; and for a second application selected at the touchscreen device, virtual rotary control widget 501 is enabled (e.g., reconfigured) with rotary controls associated with functionalities of the second application. In one or more other examples, virtual rotary control widget 501 has a screen location that is context-dependent or application-dependent. For the first application selected at the touchscreen device, virtual rotary control widget 501 is enabled (e.g., configured) at a first location of the touchscreen; and for the second application selected at the touchscreen device, virtual rotary control widget 501 is enabled (e.g., reconfigured) at a second location of the touchscreen. In one or more further examples, virtual rotary control widget 501 has a screen location and rotary controls associated with functionalities that are context-dependent or application-dependent.

In one or more examples, virtual rotary control widget 501 of FIGS. 5A, 5B, and 5C is a touch-only virtual widget. Touch-only virtual widgets provide flexible, software-defined controls without tactile feedback to the user.

In one or more other examples, the virtual rotary control widget is a virtual widget with tactile feedback, such as raised and/or textured surface features. Tactile feedback enables widget operation based on “feel” rather than solely on visual feedback. The presence of defined tactile feedback, such as guides, boundaries, textures, buttons, or knobs, helps guide a user’s finger or hand, thereby reducing accidental inputs and increasing operational accuracy. Tactile feedback also enables users to develop muscle memory during interaction, facilitating faster and more efficient operation. For example, a user may quickly adjust volume or temperature using a finger guide or knob without needing to process visual information. This improved efficiency and ease of use contribute to a more satisfying and trustworthy user experience. Such tactile interaction is particularly beneficial in environments where visual attention should remain elsewhere, such as while driving.

FIG. 5D is a side or cross-sectional view of virtual rotary control widget 501 of FIGS. 5A and 5B together with recessed finger-guiding tracks, according to one or more examples. In one or more examples, an (inner) recessed finger-guiding track 560 is formed in touch surface 550 within inner annular touch region 520, and an (outer) recessed finger-guiding track 562 is formed in touch surface 550 within outer annular touch region 522. Put another way, recessed finger-guiding track 560 comprises a depression that coincides with inner annular touch region 520, and recessed finger-guiding track 562 comprises a depression that coincides with outer annular touch region 522.

In one or more examples, respective ones of recessed finger-guiding tracks 560 and 562 comprise an arc-shaped groove within touch surface 550. Each arc-shaped groove may have a rounded concave cross-sectional profile (e.g., a substantially semicircular or U-shaped cross-section) to provide a smooth tactile guide surface for circumferential sliding movement of a user’s finger. In one or more examples, a depth or maximum depth of the track or groove is within a range of about 0.05 mm to 0.5 mm (e.g., about 0.1–0.3 mm).

In one or more examples, respective ones of recessed finger-guiding tracks 560 and 562 are formed in a protective layer (e.g., protective layer 314 of FIG. 3, which may be acrylic, Perspex, glass, or other transparent cover material) of the touch sensor or touchscreen 502. In one or more other examples, an overlay is provided over all or a portion of the touch sensor or touchscreen 502 (e.g., an overlay layer adhesively attached thereover), where the overlay includes or defines the tracks or grooves (e.g., cut-outs or cutaways) for placement over the annular touch regions of the widget.

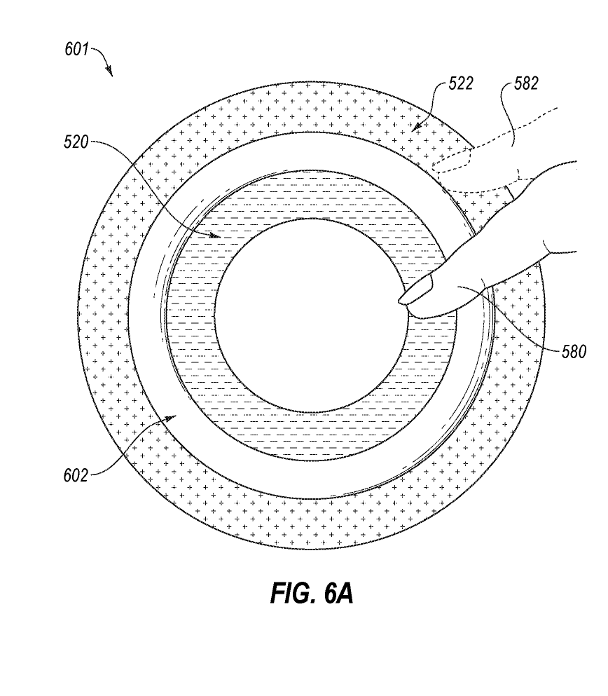

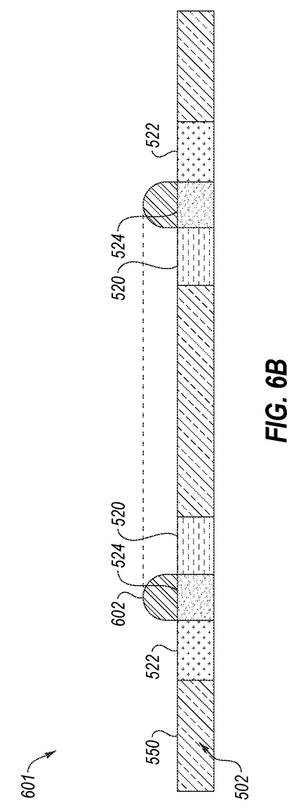

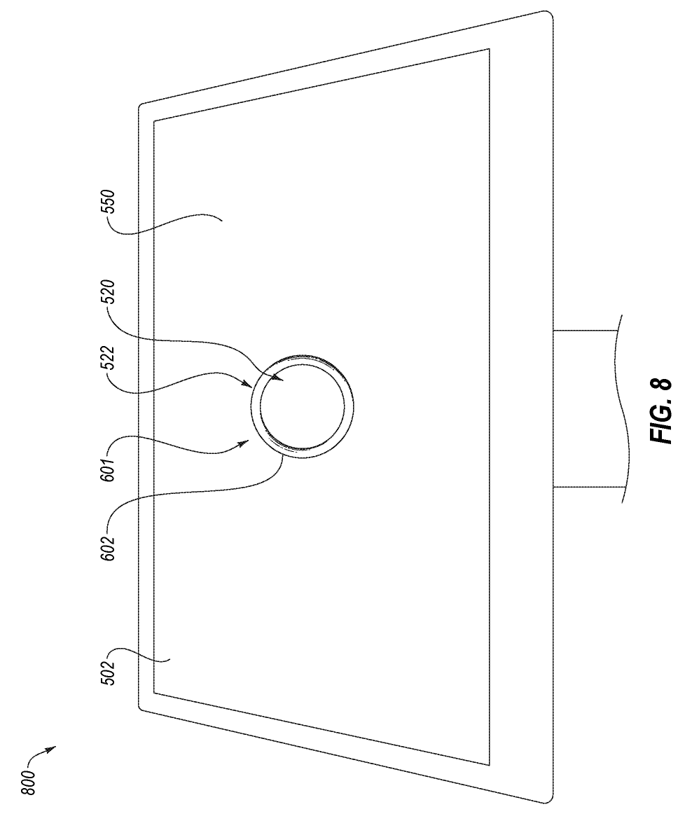

FIG. 6A is a front view of a virtual rotary control widget 601 including an annular finger guide 602, according to one or more examples. FIG. 6B is a side or cross-sectional view of virtual rotary control widget 601 of FIG. 6A. Virtual rotary control widget 601 of FIGS. 6A and 6B is substantially the same (e.g., in arrangement and/or operation) as virtual rotary control widget 501 of FIGS. 5A, 5B, and 5C, but it includes annular finger guide 602 to provide circumferential finger guidance. Additional views of annular finger guide 602 are depicted later in relation to FIGS. 8, 9A, and 9B.

In one or more examples of FIGS. 6A and 6B, annular finger guide 602 is to attach (e.g., adhesively attach) over annular region 524 between and adjacent inner annular touch region 520 and outer annular touch region 522. Annular finger guide 602 defines a raised and/or textured surface feature to guide circumferential finger movement. This provides a physical or mechanical separation between inner annular touch region 520 and outer annular touch region 522. In one or more examples, annular finger guide 602 is formed from a non-conductive material, and therefore may be referred to as a non-conductive annular finger guide. Thus, annular finger guide 602 may be used to guide circumferential finger movement along inner annular touch region 520 (e.g., finger-based touch input 580 of FIG. 6A) and/or outer annular touch region 522 (e.g., finger-based touch input 582 of FIG. 6A), without electrically interfering with touch detection. In one or more examples, annular finger guide 602 may be used to guide circumferential multi-finger movement along inner and outer annular touch regions 520 and 522 simultaneously (e.g., with simultaneous finger-based touch inputs 580 and 582 of FIG. 6A).

In one or more specific examples, the non-conductive material may be or include one or more polymeric or elastomeric materials, such as silicone rubber, thermoplastic elastomers (TPE), thermoplastic polyurethane (TPU), polycarbonate, acrylic, or similar non-conductive plastics. In one or more examples, annular finger guide 602 includes an adhesive layer to attach or mount to the touch surface. In a specific, non-limiting example, the radial thickness of annular finger guide 602 is between about 4-8 mm. In another specific, non-limiting example, the raised height of annular finger guide 602 is between about 3-10 mm.

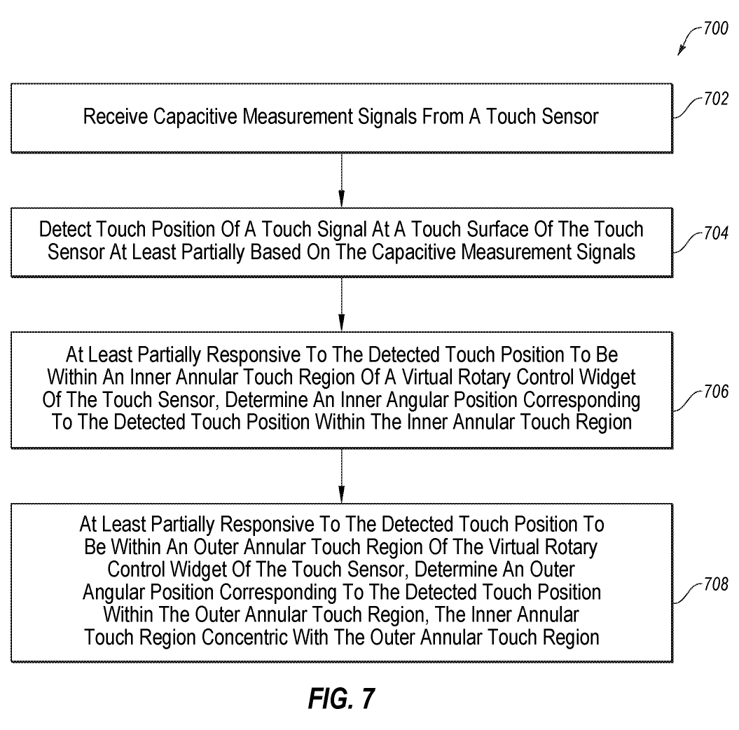

FIG. 7 is a flowchart of a method 700 of touch signal processing for a virtual rotary control widget of a touch sensor, according to one or more examples. In one or more examples, method 700 is performed by a touch controller of the touch sensor (e.g., touch controller 210 of touch sensor 222 of FIGS. 2A, 2B, and 4) to implement the virtual rotary control widget (e.g., virtual rotary control widget 501 of FIGS. 5A, 5B, 5C, and/or 5D, or virtual rotary control widget 601 of FIGS. 6A and 6B). In one or more examples, method 700 is performed by one or more processors (e.g., MCU and/or DSP of the touch controller) executing processor-executable instructions stored on a non-transitory processor-readable medium (e.g., memory of the touch controller).

At an act 702, capacitive measurement signals are received from the touch sensor. At an act 704, touch position of a touch signal at a touch surface of the touch sensor is detected at least partially based on the capacitive measurement signals. At an act 706, at least partially responsive to the detected touch position to be within an inner annular touch region of the virtual rotary control widget, an inner angular position corresponding to the detected touch position within the inner annular touch region is determined. In one or more examples, the determined inner angular position is communicated to a host controller. At an act 708, at least partially responsive to the detected touch position to be within an outer annular touch region of the virtual rotary control widget (e.g., where the inner annular touch region is concentric with the outer annular touch region), an outer angular position corresponding to the detected touch position within the outer annular touch region is determined. In one or more examples, the determined outer angular position is communicated to the host controller.

FIG. 8 is a front perspective view of a system 800 including touchscreen 502 that implements virtual rotary control widget 601 with annular finger guide 602, according to one or more examples. Virtual rotary control widget 601 with annular finger guide 602 was previously shown and described in relation to FIGS. 6A and 6B. As depicted in FIG. 8, virtual rotary control widget 601 with annular finger guide 602 is implemented with no visual indicia rendered within and/or around its concentric annular touch regions.

FIGS. 9A and 9B are left-front perspective views 900A and 900B of virtual rotary control widget 601 with annular finger guide 602 of FIG. 8, according to one or more examples. In FIGS. 9A and 9B, virtual rotary control widget 601 with annular finger guide 602 is depicted together with finger-based touch input. In particular, virtual rotary control widget 601 with annular finger guide 602 is depicted to receive a multi-finger, multi-touch input 980 (e.g., with simultaneous touch points), where one finger is provided with circumferential finger guidance along inner annular touch region 520 and another finger is provided with circumferential finger guidance along outer annular touch region 522. Here, virtual rotary control widget 601 receives multi-finger, multi-touch input 980 while annular finger guide 602 guides the circumferential multi-finger movement along inner and outer annular touch regions 520 and 522 simultaneously. In FIG. 9B, example boundaries of inner and outer annular touch regions 520 and 522 of virtual rotary control widget 601 are indicated in dashed lines.

FIG. 9C is a front view 900C of virtual rotary control widget 601 with annular finger guide 602, according to or more alternative examples. As mentioned previously, the touch controller may operate to select one of a number of discrete angular positions (e.g., angular indexes) corresponding to an identified one of a number of predefined arc regions (e.g., angular bins) within which detected x-y touch coordinate data is located. In FIG. 9C, example boundaries of inner and outer annular touch regions 520 and 522 of virtual rotary control widget 601 are again indicated in dashed lines. In addition, dashed lines are also provided to indicate some examples of predefined arc regions within inner and outer annular touch regions 520 and 522 indicating discrete angular positions.

For inner annular touch region 520 of FIG. 9C, a number of predefined arc regions 910 for inner angular position touch detection are indicated within inner annular touch region 520 as dashed lines. For outer annular touch region 522 of FIG. 9C, a number of predefined arc regions 912 for outer angular position touch detection are indicated within outer annular touch region 522 as dashed lines.

With respect to FIG. 9C, touch processing may be performed as follows, in a specific non-limiting example (e.g., for use with method 700 of FIG. 7). At least partially responsive to detected touch position (e.g., detected x-y coordinate data) to be within an identified one of the number of inner predefined arc regions 910 of inner annular touch region 520, the touch controller selects one of a number of inner angular positions (e.g., angular indexes) corresponding to the identified one of the number of inner predefined arc regions 910. The number of inner angular positions are respectively associated with the number of inner predefined arc regions 910 and indicate respective discrete angular positions around inner annular touch region 520. At least partially responsive to detected touch position (e.g., detected x-y coordinate data) to be within an identified one of the number of outer predefined arc regions 912 of outer annular touch region 522, the touch controller selects one of a number of outer angular positions (e.g., angular indexes) corresponding to the identified one of the number of outer predefined arc regions 912. The number of outer angular positions are respectively associated with the number of outer predefined arc regions 912 and indicate respective discrete angular positions around outer annular touch region 522. In one or more examples, inner annular touch region 520 may be associated with a first command, with the selected inner angular position being an input parameter to the first command; and outer annular touch region 522 may be associated with a second command, with the selected outer angular position being an input parameter to the second command.

FIG. 10 is a front view 1000 of virtual rotary control widget 601 for discrete angular position detection, according to or more alternative examples. In FIG. 10, example boundaries of inner and outer annular touch regions 520 and 522 of virtual rotary control widget 601 are indicated in solid lines, where the annular finger guide is removed. Examples of predefined arc regions within inner and outer annular touch regions 520 and 522 indicating discrete angular positions are also indicated in the figure.

For inner annular touch region 520 of FIG. 10, the number of predefined arc regions 910 for inner discrete angular position touch detection include regions P0, P1, P2, P3, P4, P5, P6, P7, P8, P9, P10, P11, P12, P13, P14, P15, P16, P17, P18, P19, P20, P21, P22, and P23 (i.e., twenty-four (24) regions for twenty-four (24) discrete angular positions). For outer annular touch region 522 of FIG. 10, a number of predefined arc regions 912 for outer discrete angular position touch detection include regions p0,p1,p2,p3, p4,p5,p6,p7,p8, p9, p10,p11,p12, p13, p14, p15,p16, p17, p18, p19, p20, p21, p22,and p23 (i.e., again, twenty-four (24) regions for twenty-four (24) discrete angular positions).

With respect to FIG. 10, touch processing may be performed as follows, in a specific non-limiting example (e.g., for use with method 700 of FIG. 7). At least partially responsive to detected touch position (e.g., detected x-y coordinate data) to be within an identified one of the number of inner predefined arc regions 910 of inner annular touch region 520, the touch controller selects one of a number of inner angular positions (e.g., angular indexes) corresponding to the identified one of the number of inner predefined arc regions 910. The number of inner angular positions are respectively associated with the number of inner predefined arc regions 910 and indicate respective discrete angular positions around inner annular touch region 520 (e.g., discrete angular positions including P0, P1, P2, P3, P4, P5, P6, P7, P8, P9, P10, P11, P12, P13, P14, P15, P16, P17, P18, P19, P20, P21, P22, and P23). At least partially responsive to detected touch position (e.g., detected x-y coordinate data) to be within an identified one of the number of outer predefined arc regions 912 of outer annular touch region 522, the touch controller selects one of a number of outer angular positions (e.g., angular indexes) corresponding to the identified one of the number of outer predefined arc regions 912. The number of outer angular positions are respectively associated with the number of outer predefined arc regions 912 and indicate respective discrete angular positions around outer annular touch region 522 (discrete angular positions including p0, p1, p2, p3, p4, p5, p6, p7, p8, p9, p10, p11, p12, p13,p14, p15, p16, p17, p18, p19, p20, p21, p22, and p23). Again, in one or more examples, inner annular touch region 520 may be associated with a first command, with the selected inner angular position being an input parameter to the first command; and outer annular touch region 522 may be associated with a second command, with the selected outer angular position being an input parameter to the second command.

As discussed in one or more examples of FIG. 10, inner annular touch region 520 of virtual rotary control widget 601 is associated with inner discrete angular position touch detection and response by the touch sensor, and outer annular touch region 522 of virtual rotary control widget 601 is associated with outer discrete angular position touch detection and response by the touch sensor. In one or more examples, virtual rotary control widget 601 is further associated with one or more annular isolation regions, such as an annular isolation region 1005, an annular isolation region 1007, and an annular isolation region 1009. Annular isolation regions 1005, 1007, and 1009 are concentric with inner annular touch region 520, outer annular touch region 522, and with each other. Annular isolation region 1005 is adjacent and between inner annular touch region 520 and outer annular touch region 522. Annular isolation region 1007 is contained within and adjacent inner annular touch region 520. Annular isolation region 1009 is outside of and adjacent annular touch region 522.

In one or more examples, respective ones of annular isolation regions 1005, 1007, and 1009 of virtual rotary control widget 601 of FIG. 10 are without position touch detection and/or response by the touch sensor. Here, the touch controller of the touch sensor may ignore or discard detected x-y touch coordinate data within each annular isolation region, or translate detected x-y touch coordinate data into an angular position but refrain from sending the angular position to the host controller, as some examples. In one or more examples, the touch sensor is to perform (e.g., standard, non-angular) touch position detection and response outside of the concentric annular touch regions of virtual rotary control widget 601 (e.g., outside of annular isolation region 1009).

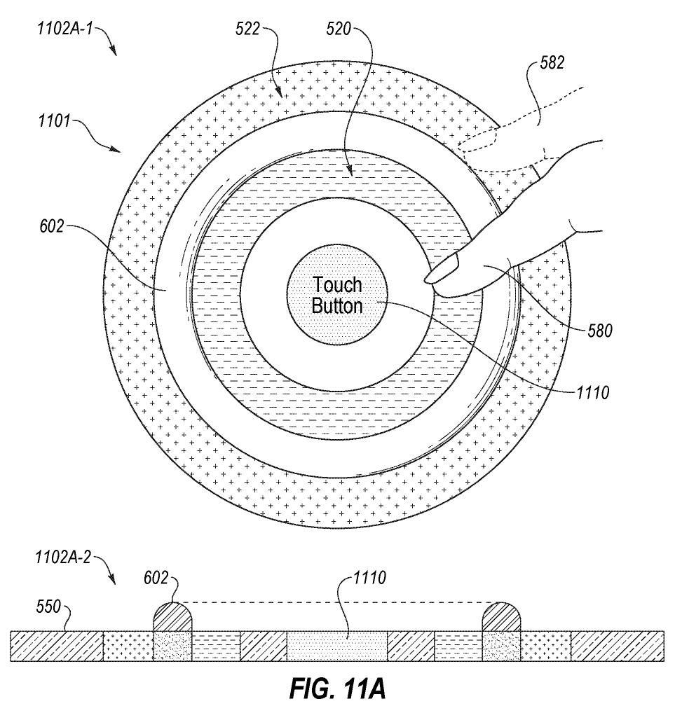

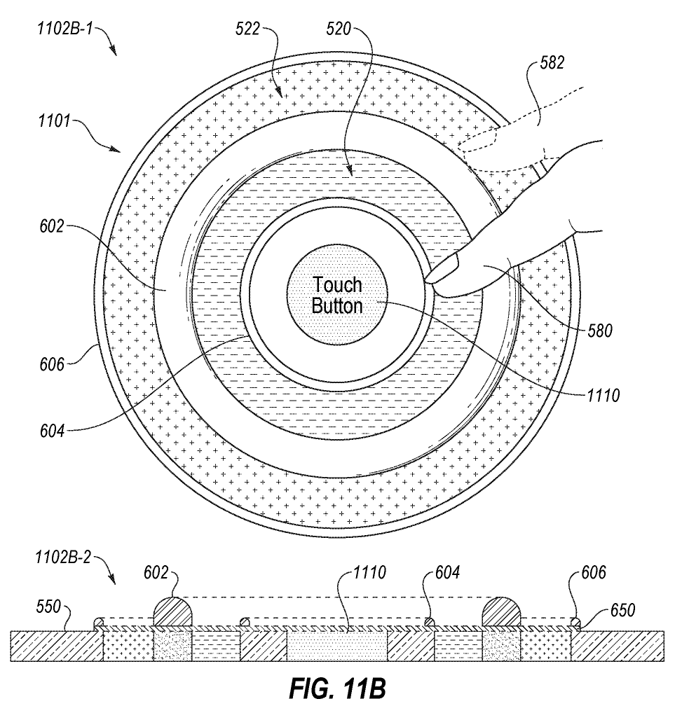

FIG. 11A includes a front view 1102A-1 and a side or cross-sectional view 1102A-2 of a virtual rotary control widget 1101, according to one or more examples. Virtual rotary control widget 1101 of FIG. 11A is substantially the same (e.g., in arrangement and/or operation) as virtual rotary control widget 501 of FIGS. 5A, 5B, and 5C and/or virtual rotary control widget 601 of FIGS. 6A and 6B, but it further includes a touch button 1110 within substantially a center or center area of virtual rotary control widget 1101.

In one or more examples, at least partially responsive to a detected touch position corresponding to touch button 1110 (e.g., within substantially the center of virtual rotary control widget 1101), the touch controller communicates the touch coordinate data (e.g., x-y touch coordinates or other indication) to the host controller, which can be interpreted as a control command and corresponding function associated with virtual rotary control widget 601.

In one or more examples, virtual rotary control widget 1101 includes multiple modes of user interaction that may be selected and set using touch button 1110. At least partially responsive to a detected touch position corresponding to touch button 1110, the touch controller switches between the multiple modes of virtual rotary control widget 1101. In one or more examples, touch button 1110 may be referred to as a mode button or mode control button.

In one or more examples, the multiple modes of user interaction include an independent control mode (or “unlocked” mode) and an interlocked control mode (or “locked” mode). In one or more specific examples, at least partially responsive to a detected touch position corresponding to touch button 1110, the touch controller switches or toggles between the independent control mode and the interlocked control mode of virtual rotary control widget 1101.

In the independent control mode, angular position touch detection and response for inner annular touch region 520, and angular position touch detection and response for outer annular touch region 522, are performed separately and independently (as discussed above in relation to FIGS. 5A, 5B, 5C, 6A, 6B, 7, 8, 9A, 9B, 9C, and 10).

In the interlocked control mode, angular position control of virtual rotary control widget 1101 may be interlocked such that angular position touch detection and response for inner annular touch region 520 and outer annular touch region 522 are performed together or cooperatively in tandem.

To illustrate, in the interlocked control mode, when touch coordinates (e.g., x-y touch coordinate data) are detected to be (e.g., only) within inner annular touch region 520 (e.g., in response to finger-based touch input 580 of FIG. 11A), the touch controller translates the touch coordinates into an inner angular touch position, and identifies a corresponding outer angular touch position corresponding to the inner angular position. The touch controller may communicate the inner angular touch position and the corresponding outer angular touch position to the host controller. In response, the host controller may interpret the inner angular touch position to be associated with a command (e.g., a first command associated with inner annular touch region 520), and the corresponding outer angular touch position to be associated with another command (e.g., a second command associated with outer annular touch region 522), and invoke both functions in response to the command and other command.

Also, in the interlocked control mode, when touch coordinates (e.g., x-y touch coordinate data) are detected to be (e.g., only) within outer annular touch region 522 (e.g., in response to finger-based touch input 582 of FIG. 11A), the touch controller translates the touch coordinates into an outer angular touch position, and identifies a corresponding inner angular touch position corresponding to the outer angular position. The touch controller may communicate the outer angular touch position and the corresponding inner angular touch position to the host controller. In response, the host controller may interpret the outer angular touch position to be associated with a command (e.g., the second command associated with outer annular touch region 522), and the corresponding inner angular touch position to be associated with another command (e.g., the first command associated with inner annular touch region 520), and invoke both functions in response to the command and other command.

In one or more examples, the above-described operation associated with the interlocked control mode of virtual rotary control widget 1101 may be applied to processing associated with discrete angular position detection described earlier in relation to FIGS. 9C and 10. At least partially responsive to detected touch position (e.g., detected x-y coordinate data) to be (e.g., only) within an identified one of the number of inner predefined arc regions of inner annular touch region 520, the touch controller selects one of a number of inner angular positions (e.g., angular indexes) corresponding to the identified one of the number of inner predefined arc regions, and also selects a corresponding one of the number of outer angular positions associated therewith. At least partially responsive to detected touch position (e.g., detected x-y coordinate data) to be (e.g., only) within an identified one of the number of outer predefined arc regions of outer annular touch region 522, the touch controller selects one of a number of outer angular positions (e.g., angular indexes) corresponding to the identified one of the number of outer predefined arc regions, and also selects a corresponding one of the number of inner angular positions associated therewith.

FIG. 11B includes a front view 1102B-1 and a side or cross-sectional view 1102B-2 of virtual rotary control widget 1101, according to one or more examples. Virtual rotary control widget 1101 of FIG. 11B is substantially the same (e.g., in arrangement and/or operation) as virtual rotary control widget 1101 of FIG. 11A, but it further includes one or more additional (non-conductive) annular finger guides in addition to annular finger guide 602.

In FIG. 11B, the one or more additional annular finger guides of virtual rotary control widget 1101 include an annular finger guide 604 and an annular finger guide 606. Annular finger guide 604 is (e.g., adhesively attached) around an inner perimeter of inner annular touch region 520. Annular finger guide 606 is (e.g., adhesively attached) around an outer perimeter of outer annular touch region 522. In one or more examples, annular finger guide 602, annular finger guide 604, and annular finger guide 606 are part of and/or provided together on (e.g., integrally formed with) a touchscreen overlay 650 or laminate on touch surface 550.

In one or more examples, annular finger guides 604 and 606, and/or touchscreen overlay 650, are formed from a non-conductive material, and therefore may be referred to as non-conductive annular finger guides or overlays. Again, the non-conductive material may be or include one or more polymeric or elastomeric materials, such as silicone rubber, TPE, TPU, polycarbonate, acrylic, or similar non-conductive plastics. In one or more examples, annular finger guides 604 and 606, and/or touchscreen overlay 650, includes an adhesive layer to attach or mount to the touch surface. In one or more examples, the radial thickness of each one of annular finger guides 604 and 606 is less than the radial thickness of annular finger guide 602. In a specific, non-limiting example, the radial thickness of each one of annular finger guides 604 and 606 is between about 2-4 mm. In one or more examples, the raised height of each one of annular finger guides 604 and 606 is less than the raised height of annular finger guide 602. In a specific, non-limiting example, the raised height of each one of annular finger guides 604 and 606 is between about 2-4 mm.

While touchscreens including virtual widgets offer greater flexibility and customization – as digital layouts can be changed easily – they may fall short in dynamic, mobile, or high-stakes environments (e.g., emergency, medical, or military). Increased physical feedback could be essential to the success of many user interfaces. For example, vehicle safety rules of the European New Car Assessment Program (Euro NCAP) were recently updated to limit the safety rating of a vehicle to only four (4) out of five (5) stars (i.e., 4/5 stars) if all of the controls of the vehicle are touch-only. This rule change may signify a return to use of more (e.g., physical or tactile) “buttons” in such interface systems. Hybrid solutions, such as KoD, aim to combine the adaptability of touchscreens with the intuitive control of physical interaction, delivering a more balanced and user-friendly experience.

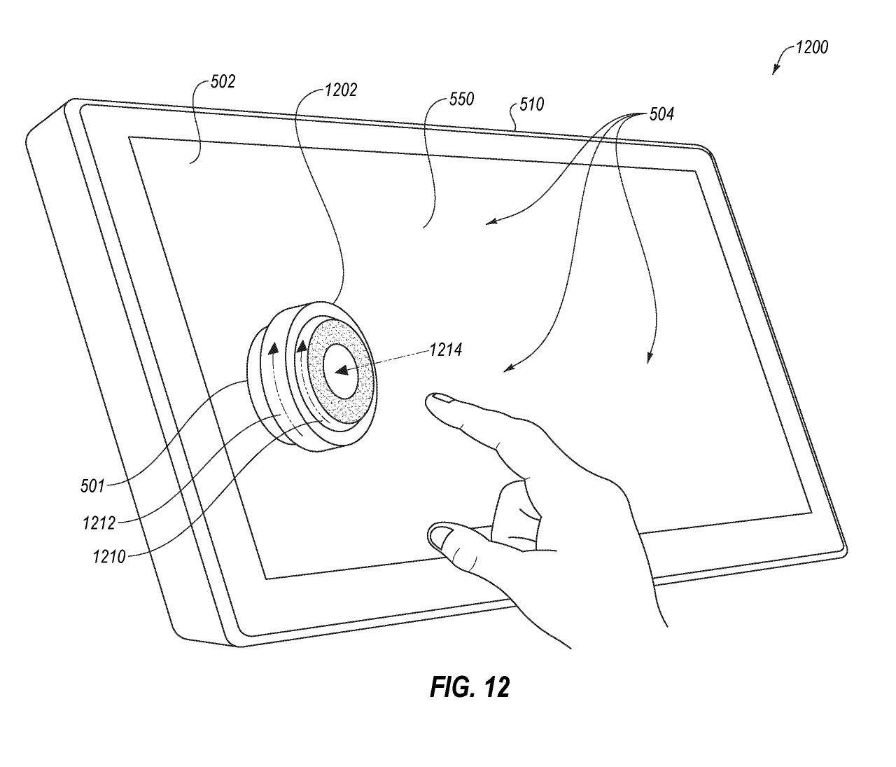

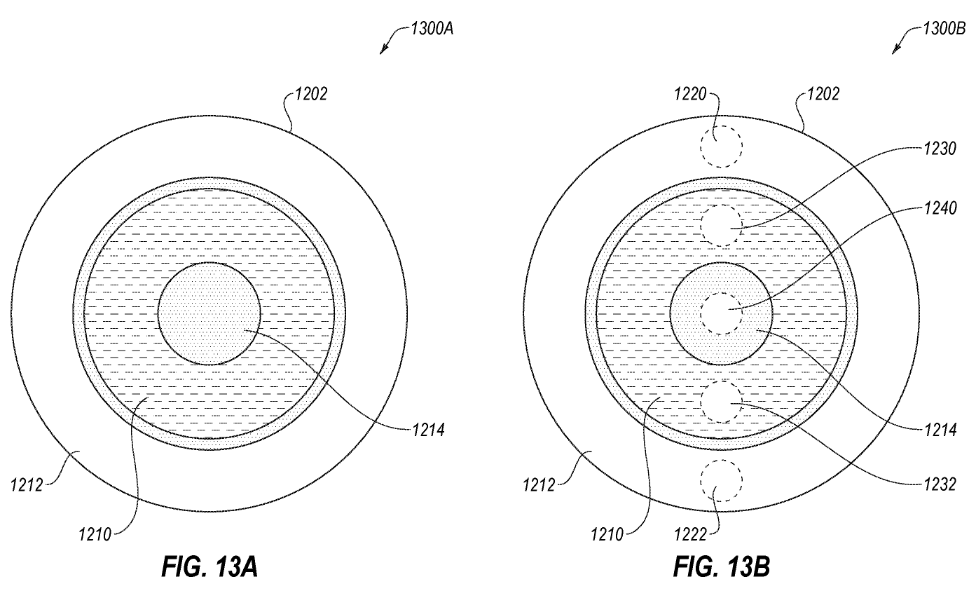

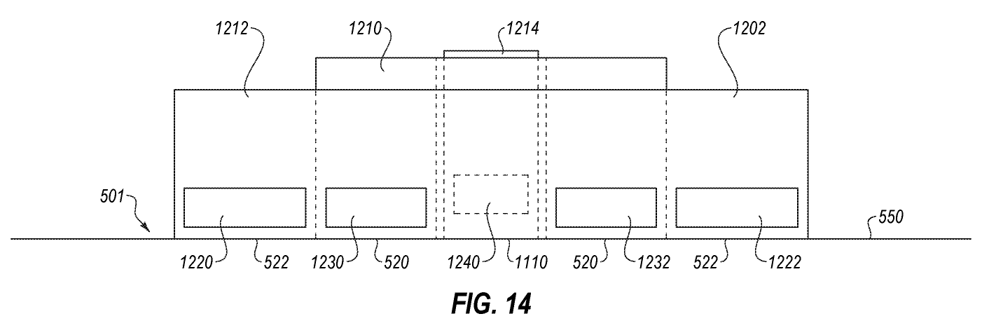

FIG. 12 is a perspective view of a system 1200 including touchscreen device 510 of FIG. 5A operative with a KoD device 1202, according to one or more examples. FIGS. 13A and 13B are respective frontal views 1300A and 1300B of KoD device 1202 of FIG. 12, with FIG. 13B indicating a number of conductive pads thereof (e.g., conductive pads 1220, 1222, 1230, 1232, and 1240) in dashed lines. FIG. 14 is a cross-sectional view of KoD device 1202 of FIGS. 12, 13A, and 13B, also indicating the number of conductive pads at a bottom surface of KoD device 1202.

In the frontal views (FIGS. 13A and 13B), KoD device 1202 may have any one of a variety of different shapes, such as a circular shape for rotational positioning, or alternatively, a polygonal shape, a square shape, a triangular shape, and so on. KoD device 1202 may be made of any one or more of a variety of plastic materials, such as rigid and/or flexible plastic materials, including materials such as polycarbonate, nylon, ABS, polypropylene, and so on, or other materials. Conductive pads 1220, 1222, 1230, 1232, and 1240 (FIGS. 13B and 14) may be made of metal or conductive rubber, as some examples.

In one or more examples, KoD device 1202 is a user interface component adapted to mount to touch surface 550 (e.g., adhesively attached thereto) over virtual rotary control widget 501. KoD device 1202 combines physical control via a rotary knob – notably, a dual concentric rotary knob – with capacitive touch sensing using conductive pads (FIGS. 13B and 14). In one or more examples, virtual rotary control widget 501 has the same arrangement and/or operation as previously described, but KoD device 1202 provides a physical interface mechanism to the virtual widget for physical user control.

According to one or more examples, the dual concentric rotary knob of KoD device 1202 includes an inner rotary position mechanism 1210 and an outer rotary position mechanism 1212 arranged concentrically. With the dual concentric rotary knob, each “knob” is independently rotatable about a common axis.

In one or more examples, inner rotary position mechanism 1210 includes conductive pads 1230 and 1232 (FIGS. 13B and 14) on an inner rotatable bottom portion thereof. Outer rotary position mechanism 1212 includes conductive pads 1220 and 1222 (FIGS. 13B and 14) on an outer rotatable bottom portion thereof. When KoD device 1202 is properly mounted on touch surface 550, conductive pads 1230 and 1232 on the inner rotatable bottom portion align with inner annular touch region 520 (FIG. 14) of virtual rotary control widget 501. In addition, conductive pads 1220 and 1222 on the outer rotatable bottom portion align with the outer annular touch region 522 (FIG. 14) of virtual rotary control widget 501.

In operation, conductive pads 1230 and 1232 on the inner rotatable bottom portion make capacitive contact (e.g., without physical contact) with touch points along inner annular touch region 520, and the touch sensor tracks pad movement and determines the inner rotation angle (e.g., and direction) thereof. As inner rotary position mechanism 1210 is rotated, the positions of conductive pads 1230 and 1232 change relative to inner annular touch region 520, simulating circumferential finger movement within inner annular touch region 520. In one or more examples, the inner rotary input allows a user to turn or rotate the device to control parameters of touchscreen 502. Similarly, conductive pads 1220 and 1222 on the outer rotatable bottom portion make capacitive contact (e.g., without physical contact) with touch points along outer annular touch region 522 of virtual rotary control widget 501, and the touch sensor tracks pad movement and determines the outer rotation angle (e.g., and direction) thereof. As outer rotary position mechanism 1212 is rotated, the positions of conductive pads 1220 and 1222 change relative to outer annular touch region 522, simulating circumferential finger movement within outer annular touch region 522. In one or more examples, the outer rotary input allows the user to turn or rotate the device to control additional parameters of touchscreen 502. In one or more examples, each one of inner rotary position mechanism 1210 and outer rotary position mechanism 1212 is provided with detents (e.g., clicking stops) for tactile feedback. As is apparent, the design of KoD device 1202 offers a cost-effective and intuitive input method, especially useful in automotive, audio, and industrial interfaces.

In one or more examples, KoD device 1202 also includes a push button device 1214 substantially in a center of the device. In one or more examples, push button device 1214 may be referred to as a central push button mechanism. Push button device 1214 includes a member connected to a conductive pad 1240 (FIGS. 13B and 14) at the bottom surface of the device. When KoD device 1202 is properly mounted, conductive pad 1240 is in alignment with touch button 1110 of virtual rotary control widget 501 (FIG. 14).

Push button device 1214 has a normal or rest position and a depressed position. In the normal or rest position, push button device 1214 maintains conductive pad 1240 at a sufficient distance away from touch surface 550 to avoid capacitive contact with touch button 1110 of virtual rotary control widget 501. The depressed position of push button device 1214 is established in response to vertical button depression (FIG. 12) by the user. Upon vertical button depression, the member of push button device 1214 extends towards touch surface 550 so that conductive pad 1240 makes capacitive contact (e.g., without physical contact) with touch button 1110 of virtual rotary control widget 501.

In one or more examples, the touch controller may switch between the multiple modes of the virtual rotary control widget responsive to the capacitive contact (e.g., without physical contact) with touch button 1110. In one or more specific examples, the touch controller switches or toggles between the independent control mode and the interlocked control mode of the virtual rotary control widget in response to capacitive contact with touch button 1110, as discussed earlier above in relation to FIG. 11A.

In one or more alternative examples, KoD device 1202 excludes the push button device 1214 and instead defines a central aperture substantially at the center of the device. With this arrangement, KoD device 1202 may be referred to as an annular KoD device (e.g., with a ring-shaped arrangement). The central aperture allows the user to insert or position a fingertip within the opening to make capacitive contact with touch button 1110 (FIG. 14). In response to detection of the touch input, the touch controller may switch between multiple modes of the virtual rotary control widget, including switching or toggling between an independent control mode and an interlocked control mode, as discussed above.

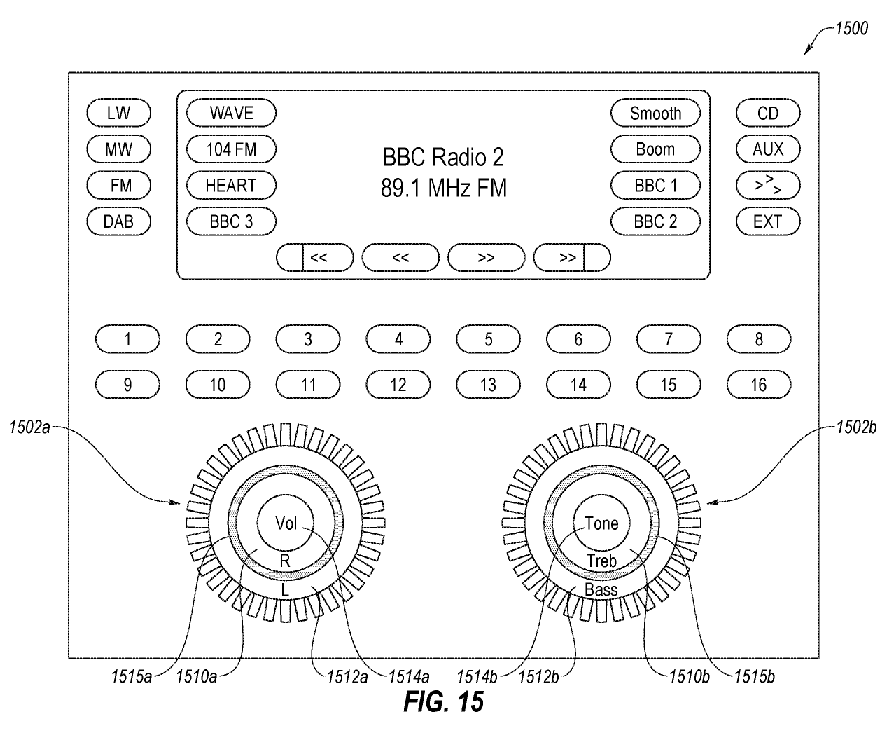

FIG. 15 is a visual presentation 1500 of an audio system on a touchscreen implementing one or more virtual rotary control widgets 1502a and 1502b, according to one or more examples. The use of virtual rotary control widgets 1502a and 1502b in the audio system of FIG. 15 illustrates one of many possible applications of the widgets of the disclosure.

In the example of FIG. 15, the audio system is associated with an FM radio system adapted to receive FM broadcast signals and provide audio output (e.g., from “BBC Radio 2,” at 89.1 MHz FM). In this system, virtual rotary control widget 1502a is adapted for control over a “Volume” (Vol) of the audio system and virtual rotary control widget 1502b is adapted for control over a “Tone” of the audio system.

Virtual rotary control widget 1502a for volume control includes an inner annular touch region 1510a (an “inner rotary control”) associated with volume control over a right (“R”) channel and an outer annular touch region 1512a (an “outer rotary control”) associated with volume control over a left (“L”) channel. Inner annular touch region 1510a is concentric with outer annular touch region 1512a. In one or more examples, an annular finger guide 1515a is attached to the touch surface (e.g., in an annular region) in between and adjacent inner annular touch region 1510a and outer annular touch region 1512a. In one or more other examples, an annular isolation region is provided between and adjacent inner annular touch region 1510a and outer annular touch region 1512a without the annular finger guide.

In one or more examples, the user may use one finger to adjust left or right volume by circumferential finger movement around (e.g., only) one of inner annular touch region 1510a or outer annular touch region 1512a. In one or more additional examples, the user may use two fingers to adjust left and right volume simultaneously by multi-finger circumferential movement around both inner annular touch region 1510a and outer annular touch region 1512a at the same time.

In one or more examples, a mode button 1514a is provided at a center region of virtual rotary control widget 1502a. Mode button 1514a is a touch button (e.g., touch button 1110 of FIG. 11A) that allows the user to change the mode of operation of virtual rotary control widget 1502a. In one or more examples, virtual rotary control widget 1502a may operate in an independent control mode or an interlocked control mode. In response to detected touch at mode button 1514a, virtual rotary control widget 1502a may switch or toggle between the independent control mode and the interlocked control mode. In the independent control mode, left and right volume are adjusted separately and independently in response to circumferential finger movement around (e.g., only) one of inner annular touch region 1510a or outer annular touch region 1512a. In the interlocked control mode, left and right volume are adjusted together in cooperation in response to circumferential finger movement around (e.g., only) one of inner annular touch region 1510a or outer annular touch region 1512a. That is, the inner and outer rotary controls are synchronized or locked together so that controlling only one of them causes both of them to be controlled together.

Virtual rotary control widget 1502b for tone control includes an inner annular touch region 1510b (an “inner rotary control”) associated with tone control over treble (“Treb”) and an outer annular touch region 1512b (an “outer rotary control”) associated with tone control over bass (“Bass”). Inner annular touch region 1510b is concentric with outer annular touch region 1512b. In one or more examples, an annular finger guide 1515b is attached to the touch surface (e.g., in an annular region) in between and adjacent inner annular touch region 1510b and outer annular touch region 1512b. In one or more other examples, an annular isolation region is provided between and adjacent inner annular touch region 1510b and outer annular touch region 1512b without the annular finger guide.

In one or more examples, the user may use one finger to adjust treble and bass by circumferential finger movement around (e.g., only) one of inner annular touch region 1510b or outer annular touch region 1512b. In one or more additional examples, the user may use two fingers to adjust treble and bass simultaneously by multi-finger circumferential movement around both inner annular touch region 1510b and outer annular touch region 1512b at the same time.

In one or more examples, a mode button 1514b is provided at a center region of virtual rotary control widget 1502b. Mode button 1514b is a touch button (e.g., touch button 1110 of FIG. 11A) that allows the user to change the mode of operation of virtual rotary control widget 1502b. In one or more examples, virtual rotary control widget 1502b may operate in an independent control mode or an interlocked control mode. In response to detected touch at mode button 1514b, virtual rotary control widget 1502b may switch or toggle between the independent control mode and the interlocked control mode. In the independent control mode, treble and bass are adjusted separately and independently in response to circumferential finger movement around (e.g., only) one of inner annular touch region 1510b or outer annular touch region 1512b. In the interlocked control mode, treble and bass are adjusted together in cooperation in response to circumferential finger movement around (e.g., only) one of inner annular touch region 1510b or outer annular touch region 1512b. That is, the inner and outer rotary controls are synchronized or locked together so that controlling only one of them causes both of them to be controlled together.

Again, the use of virtual rotary control widgets 1502a and 1502b in the audio system of FIG. 15 illustrates only one of many possible applications of the widgets of the disclosure. The dual concentric rotary control using a virtual rotary control widget of the present disclosure may be applied to many other suitable types of user interface applications, including human-machine interface (HMI) applications. As some examples, in a user interface or HMI application, the inner rotary control may be used for fine adjustment and the outer rotary control may be used for coarse adjustment (e.g., dual-resolution control); in a climate control application, the inner rotary control may be used for temperature and the outer rotary control may be used for fan speed; in a navigation/infotainment application, the inner rotary control may be used for scrolling and the outer rotary control may be used for zoom or map rotation; in a lighting control application, the inner rotary control may be used for brightness and the outer rotary control may be used for color temperature or hue; in a camera control application, the inner rotary control may be used for focus and the outer rotary control may be used for zoom; in a smart home control application, the inner rotary control may be used for device selection and an outer rotary control may be used for parameter adjustment (e.g., thermostat or dimmer level); in a media playback application, the inner rotary control may be used for track scrubbing and the outer rotary control may be used for playback speed or playlist navigation; in an equalizer (EQ) control application, the inner rotary control may be used for frequency band (or EQ band) selection and the outer rotary control may be used for overall gain range selection; in a gaming control application, the inner rotary control may be used for weapon selection and an outer rotary control may be used for aiming sensitivity or zoom level; and in an image editing application, an inner rotary control may be used for brush size and an outer rotary control may be used for opacity or hardness. Of course, in any of the above examples, the roles of the inner rotary control and the outer rotary controls may be switched.

In one or more examples, the virtual rotary control widget may be reconfigurable. For example, the virtual rotary control widget may be associated with functionalities (e.g., assigned to functions) that are context-sensitive, context-dependent, and/or application-dependent. In one illustrative example, the outer rotary control can be used to select one of a set of features, such as “CD player,” “radio,” or other “source input” of an audio amplifier, or to select one of a number of heater rings 1, 2, 3, or 4 on a domestic kitchen cooktop. Here, functionality associated with the inner rotary control may be automatically selected and set in response to the outer rotary control selection. For example, the inner rotary control can be automatically selected and set to CD player track selection in response to the CD player selection, FM tuner selection in response to the radio selection, or heater ring temperature selection in response to the heater ring selection, and so on.

Accordingly, the virtual rotary control widget may have rotary controls associated with functionalities that are context-dependent or application-dependent (e.g., set or enabled “on-the-fly” responsive to context or application). Such operation may be provided through processing of the touch controller, the host controller, or both the touch controller and the host controller. For a first application selected at the touchscreen device, the virtual rotary control widget is enabled (e.g., configured) with rotary controls associated with functionalities of the first application; and for a second application selected at the touchscreen device, the virtual rotary control widget is enabled (e.g., reconfigured) with rotary controls associated with functionalities of the second application. In one or more other examples, the virtual rotary control widget has a screen location that is context-dependent or application-dependent. For the first application selected at the touchscreen device, the virtual rotary control widget is enabled (e.g., configured) at a first location of the touchscreen; and for the second application selected at the touchscreen device, the virtual rotary control widget is enabled (e.g., reconfigured) at a second location of the touchscreen. In one or more further examples, the virtual rotary control widget has a screen location and rotary controls associated with functionalities that are context-dependent or application-dependent.

In the examples of FIGS. 5A, 5B, 5C, 5D, 6A, 6B, 7, 9C, 10, 11A, and 15, the virtual rotary control widget was described to have an “absolute” angular position detection operation. Using absolute angular position detection, the widget determines an absolute angular position corresponding to a detected touch position within an annular touch region. That is, the specific angular position that is determined corresponds directly, at least generally, to the detected touch position within the annular touch region. In one or more alternative examples of FIGS. 5A, 5B, 5C, 5D, 6A, 6B, 7, 9C, 10, 11A, and 15, the virtual rotary control widget has a “relative” angular position detection operation. Using relative angular position detection, the widget determines a relative angular position that is relative to the actual detected touch position. More particularly, the widget determines a relative angular position based on the difference (e.g., an “angular position difference”) between a newly-initiated, actual detected touch position and the previously-maintained position setting. In one or more examples, the widget links or equates the newly-initiated, actual detected touch position with the previously-maintained position setting (e.g., changing the reference point or frame of reference), and determines subsequent relative angular positions responsive to circumferential finger movement based on the sum of the subsequently detected actual touch position and the angular position difference. Such enhanced operation may be performed by the touch controller, the host controller, or both. Preferably, in one or more examples using relative angular position detection, an inner angular position visual indicator is presented at the current angular position setting within the inner annular touch region (e.g., maintained during and/or after release of the user’s touch), and an outer angular position visual indicator is presented at the current angular position setting within the outer annular touch region (e.g., maintained during and/or after release of the user’s touch).

To better illustrate relative angular position detection, consider a virtual rotary control widget having volume control functionality, where the volume setting of the widget is set at “6” (i.e., 6 out of 10). A user reaches to touch the widget at position “10” (i.e., 10 out of 10). Using absolute angular position detection operation, the functional response to the current touch of the widget is to issue a volume command with parameter setting of “10,” and thereafter control the volume up or down relative to the volume setting of “10” based on circumferential finger movement of the user. Using relative angular position detection operation, the functional response to the current touch of the widget is to issue a volume command with parameter setting of “6” (i.e., the previously-maintained position setting), or a null command (no response), and thereafter control the volume up or down relative to the volume setting of “6” based on circumferential finger movement of the user (i.e., despite the user starting at “10”). Responsive to circumferential finger movement, the widget determines subsequent relative angular positions such that the angular position difference of four (4) (i.e., 10–6=4) is maintained relative to the subsequent actual detected touch positions.

In one or more examples throughout the disclosure, the virtual rotary control widget includes only two (2) annular touch regions, namely, an inner annular touch region and an outer annular touch region as discussed. In one or more other examples, the virtual rotary control widget includes three (3) or more annular touch regions arranged and operating in the same or similar manner consistent with the annular touch regions described herein.

Thus, as described herein, concentric rotary control through use of virtual rotary control widgets may be provided at a touch surface of the touchscreen. Instead of having physically separate controls, techniques and mechanisms of the disclosure bring them together, combined into a unified, concentric control. In one or more examples, inner and outer rotary controls of the virtual rotary control widgets may be separated using annular isolation regions and/or annular finger guides to prevent touches on the inner and outer regions from interfering with each other, and/or use annular finger guides and/or recessed finger-guiding tracks to guide circumferential finger movement.

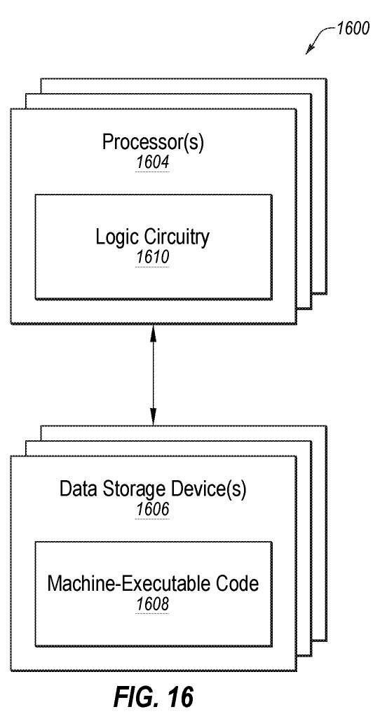

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 16 illustrates non-limiting examples of implementations of functional elements disclosed herein. In some examples, some or all portions of the functional elements disclosed herein may be performed by hardware specially implemented for carrying out the functional elements.

FIG. 16 is a block diagram of circuitry 1600 that, in some examples, may be used to implement various functions, operations, acts, processes, and/or methods disclosed herein. Circuitry 1600 includes one or more processors 1604 (sometimes referred to herein as “processor 1604”) operably coupled to one or more data storage devices (sometimes referred to herein as “storage 1606”). Storage 1606 includes machine-executable code 1608 stored thereon, and processor 1604 includes a logic circuitry 1610. Machine-executable code 1608 includes information describing functional elements that may be implemented by (e.g., performed by) logic circuitry 1610. Logic circuitry 1610 is adapted to implement (e.g., perform) the functional elements described by machine-executable code 1608. Circuitry 1600, when executing the functional elements described by machine-executable code 1608, should be considered as special purpose hardware for carrying out functional elements disclosed herein. In some examples, processor 1604 may perform the functional elements described by machine-executable code 1608 sequentially, concurrently (e.g., on one or more different hardware platforms), or in one or more parallel process streams.

When implemented by logic circuitry 1610 of processor 1604, machine-executable code 1608 adapts processor 1604 to perform operations of examples disclosed herein. For example, machine-executable code 1608 may be to adapt processor 1604 to perform at least a portion or a totality of methods or processes described herein (e.g., methods or processes associated with virtual rotary control widget 501 of FIG. 5A, virtual rotary control widget 601 of FIG. 6A, and method 700 of FIG. 7 with associated processing acts described in relation to the same, whether or not the methods or processes are combined with additional features discussed throughout the disclosure). As described earlier above, configuration parameters for operation of the virtual rotary control widget may be stored in nonvolatile memory, where widget operation involves x-y coordinate position data being translated into angular touch position data according to the configuration parameters.

Processor 1604 may include a general purpose processor, a special purpose processor, a CPU, a microcontroller, a programmable logic controller (PLC), a DSP, an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to machine-executable code 1608 (e.g., software code, firmware code, hardware descriptions) related to examples of the disclosure. It is noted that a general-purpose processor (may also be referred to herein as a host processor or simply a host) may be a microprocessor, but in the alternative, processor 1604 may include any conventional processor, controller, microcontroller, or state machine. Processor 1604 may also be implemented as a combination of computing devices, such as a combination of a DSP and a microprocessor, a plurality of microprocessors, one or more microprocessors in conjunction with a DSP core, or any other such configuration.

In some examples, storage 1606 includes volatile data storage (e.g., RAM), non-volatile data storage (e.g., Flash memory, a hard disc drive, a solid-state drive, erasable programmable read-only memory (EPROM), etc.). In some examples, processor 1604 and storage 1606 may be implemented into a single device (e.g., a semiconductor device product, a system on chip (SOC), etc.). In some examples, processor 1604 and storage 1606 may be implemented into separate devices.

In some examples, machine-executable code 1608 may include computer-readable instructions (e.g., software code, firmware code). By way of non-limiting example, the computer-readable instructions may be stored by storage 1606, accessed directly by processor 1604, and executed by processor 1604 using at least logic circuitry 1610. Also by way of non-limiting example, the computer-readable instructions may be stored on storage 1606, transferred to a memory device (not shown) for execution, and executed by processor 1604 using at least logic circuitry 1610. Accordingly, in some examples, logic circuitry 1610 includes electrically configurable logic circuitry 1610.

In some examples, machine-executable code 1608 may describe hardware (e.g., circuitry) to be implemented in logic circuitry 1610 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, SystemVerilog, and/or very large-scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuitries (e.g., gates, flip-flops, registers, without limitation) of logic circuitry 1610 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, machine-executable code 1608 may include an HDL, an RTL, a GL description, a mask level description, other hardware description, or any combination thereof.

In examples where machine-executable code 1608 includes a hardware description (at any level of abstraction), a system (not shown, but including storage 1606) may be to implement the hardware description described by machine-executable code 1608. By way of non-limiting example, processor 1604 may include a programmable logic device (e.g., an FPGA or a PLC) and logic circuitry 1610 may be electrically controlled to implement circuitry corresponding to the hardware description into logic circuitry 1610. Also by way of non-limiting example, logic circuitry 1610 may include hard-wired logic manufactured by a manufacturing system (not shown, but including storage 1606) according to the hardware description of machine-executable code 1608.

Regardless of whether machine-executable code 1608 includes computer-readable instructions or a hardware description, logic circuitry 1610 is adapted to perform the functional elements described by machine-executable code 1608 when implementing the functional elements of machine-executable code 1608. It is noted that although a hardware description may not directly describe functional elements, a hardware description indirectly describes functional elements that the hardware elements described by the hardware description are capable of performing.

As used in the disclosure, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the disclosure may be implemented as objects or processes that execute on the computing system (e.g., as separate threads). While some of the system and methods described in the disclosure are generally described as being implemented in software (stored on and/or executed by general purpose hardware), specific hardware implementations or a combination of software and specific hardware implementations are also possible and contemplated.

As used in the disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

A non-exhaustive, non-limiting list of examples follows. Not each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.

Example 1: An apparatus comprising: a touch sensor having a virtual rotary control widget, the virtual rotary control widget associated with multiple concentric annular touch regions on a touch surface of the touch sensor, the multiple concentric annular touch regions including an inner annular touch region and an outer annular touch region, the inner annular touch region concentric with the outer annular touch region, the inner annular touch region associated with inner angular position touch detection and response by the touch sensor, the outer annular touch region associated with outer angular position touch detection and response by the touch sensor.

Example 2: The apparatus according to Example 1, wherein the virtual rotary control widget is associated with an annular isolation region between and adjacent the inner annular touch region and the outer annular touch region, the annular isolation region without position touch detection and/or response by the touch sensor.

Example 3: The apparatus according to Examples 1 and 2, comprising: a non-conductive annular finger guide, the non-conductive annular finger guide to attach over an annular region substantially between the inner annular touch region and the outer annular touch region.

Example 4: The apparatus according to any of Examples 1 through 3, comprising: one or more additional non-conductive annular finger guides, the one or more additional non-conductive annular finger guides around an inner perimeter of the inner annular touch region, an outer perimeter of the outer annular touch region, or both the inner perimeter and the outer perimeter.

Example 5: The apparatus according to any of Examples 1 through 4, comprising: an inner recessed finger-guiding track substantially within the inner annular touch region; and an outer recessed finger-guiding track substantially within the outer annular touch region.

Example 6: The apparatus according to any of Examples 1 through 5, comprising: a touch controller of the touch sensor, the touch controller including one or more processors and processor-executable instructions to implement the virtual rotary control widget of the touch sensor, the touch controller to provide the inner angular position touch detection and response related to the inner annular touch region, the touch controller to provide the outer angular position touch detection and response related to the outer annular touch region.

Example 7: The apparatus according to any of Examples 1 through 6, comprising: a rotary knob, the rotary knob to mount on the touch surface of the touch sensor over the multiple concentric annular touch regions of the virtual rotary control widget, the rotary knob including: an inner rotary position mechanism, the inner rotary position mechanism including an inner rotatable bottom portion having at least a first conductive pad to provide inner angular position touch within the inner annular touch region; and an outer rotary position mechanism, the outer rotary position mechanism including an outer rotatable bottom portion having at least a second conductive pad to provide outer angular position touch within the outer annular touch region.

Example 8: A method comprising: receiving capacitive measurement signals from a touch sensor; detecting touch position of a touch signal at a touch surface of the touch sensor at least partially based on the capacitive measurement signals; at least partially responsive to the detected touch position to be within an inner annular touch region of a virtual rotary control widget of the touch sensor, determining an inner angular position corresponding to the detected touch position within the inner annular touch region; and at least partially responsive to the detected touch position to be within an outer annular touch region of the virtual rotary control widget of the touch sensor, determining an outer angular position corresponding to the detected touch position within the outer annular touch region, the inner annular touch region concentric with the outer annular touch region.

Example 9: The method according to Example 8, comprising: at least partially responsive to the detected touch position to be within the inner annular touch region, communicating the inner angular position to a host controller; and at least partially responsive to the detected touch position to be within the outer annular touch region, communicating the outer angular position to the host controller.

Example 10: The method according to Examples 8 and 9, comprising: at least partially responsive to the detected touch position to be within substantially a center of the virtual rotary control widget, switching between multiple modes of the virtual rotary control widget, the multiple modes including an independent control mode and an interlocked control mode.

Example 11: The method according to any of Examples 8 through 10, wherein the virtual rotary control widget includes an independent control mode in which each said determining is performed independently responsive to the detected touch position, the virtual rotary control widget further including an interlocked control mode comprising: at least partially responsive to the detected touch position to be within the inner annular touch region, identifying a corresponding outer angular position corresponding to the inner angular position within the inner annular touch region; and at least partially responsive to the detected touch position to be within the outer annular touch region, identifying a corresponding inner angular position corresponding to the outer angular position within the outer annular touch region.

Example 12: The method according to any of Examples 8 through 11, comprising: at least partially responsive to the detected touch position to be within the inner annular touch region, communicating the inner angular position and the corresponding outer angular position to a host controller; and at least partially responsive to the detected touch position to be within the outer annular touch region, communicating the outer angular position and the corresponding inner angular position to the host controller.

Example 13: The method according to any of Examples 8 through 12, comprising: at least partially responsive to the detected touch position to be within an identified one of a number of inner predefined arc regions of the inner annular touch region, selecting one of a number of inner angular positions corresponding to the identified one of the number of inner predefined arc regions, the number of inner angular positions respectively associated with the number of inner predefined arc regions and indicating respective discrete angular positions around the inner annular touch region; and at least partially responsive to the detected touch position to be within an identified one of a number of outer predefined arc regions of the outer annular touch region, selecting one of a number of outer angular positions corresponding to the identified one of the number of outer predefined arc regions, the number of outer angular positions respectively associated with the number of outer predefined arc regions and indicating respective discrete angular positions around the outer annular touch region.

Example 14: The method according to any of Examples 8 through 13, wherein the virtual rotary control widget includes an independent control mode in which each said selecting is performed independently responsive to the detected touch position, the virtual rotary control widget further including an interlocked control mode comprising: at least partially responsive to the detected touch position to be within the identified one of the number of inner predefined arc regions of the inner annular touch region, selecting a corresponding one of the number of outer angular positions corresponding to the selected one of the number of inner angular positions; and at least partially responsive to the detected touch position to be within the identified one of the number of outer predefined arc regions of the outer annular touch region, selecting a corresponding one of the number of inner angular positions corresponding to the selected one of the number of outer angular positions.

Example 15: The method according to any of Examples 8 through 14, wherein the method is performed by a touch controller of the touch sensor to implement the virtual rotary control widget.

Example 16: The method according to any of Examples 8 through 15, wherein the method is performed by one or more processors executing processor-executable instructions stored on a non-transitory processor-readable medium.

Example 17: An apparatus comprising: a capacitive touch system including: a touch sensor; a touch controller of the touch sensor; a virtual rotary control widget implemented at the touch sensor in cooperation with the touch controller, the virtual rotary control widget associated with multiple concentric annular touch regions on a touch surface of the touch sensor, the multiple concentric annular touch regions including an inner annular touch region and an outer annular touch region, the inner annular touch region concentric with the outer annular touch region; and the touch controller to: receive capacitive measurement signals from the touch sensor; detect touch position of a touch signal at a touch surface of the touch sensor at least partially based on the capacitive measurement signals; at least partially responsive to the detected touch position to be within the inner annular touch region, determine an inner angular position corresponding to the detected touch position within the inner annular touch region; and at least partially responsive to the detected touch position to be within the outer annular touch region, determine an outer angular position corresponding to the detected touch position within the outer annular touch region.

Example 18: The apparatus according to Example 17, wherein the virtual rotary control widget is associated with an annular isolation region between and adjacent the inner annular touch region and the outer annular touch region, the annular isolation region without position touch detection and/or response by the touch sensor.

Example 19: The apparatus according to Examples 17 and 18, comprising: a non-conductive annular finger guide, the non-conductive annular finger guide to attach over an annular region substantially between the inner annular touch region and the outer annular touch region.

Example 20: The apparatus according to any of Examples 17 through 19, wherein the touch controller includes input/output (I/O) interface circuitry for coupling to a host controller, and wherein: the touch controller is to: communicate, to the host controller, the inner angular position at least partially responsive to the detected touch position to be within the inner annular touch region; and communicate, to the host controller, the outer angular position at least partially responsive to the detected touch position to be within the outer annular touch region.

Example 21: The apparatus according to any of Examples 17 through 20, wherein: the touch controller is to: at least partially responsive to the detected touch position to be within substantially a center of the virtual rotary control widget, switching between multiple modes of the virtual rotary control widget, the multiple modes including an independent control mode and an interlocked control mode.

Example 22: The apparatus according to any of Examples 17 through 21, wherein the virtual rotary control widget includes an independent control mode in which the touch controller is to determine the inner angular position and determine the outer angular position independently in response to the detected touch position, the virtual rotary control widget further including an interlocked control mode, and wherein: the touch controller is to, in the interlocked control mode: at least partially responsive to the detected touch position to be within the inner annular touch region, identify a corresponding outer angular position corresponding to the inner angular position within the inner annular touch region; and at least partially responsive to the detected touch position to be within the outer annular touch region, identify a corresponding inner angular position corresponding to the outer angular position within the outer annular touch region.

Example 23: The apparatus according to any of Examples 17 through 22, comprising: a rotary knob, the rotary knob to mount on the touch surface of the touch sensor over the multiple concentric annular touch regions of the virtual rotary control widget, the rotary knob including: an inner rotary position mechanism, the inner rotary position mechanism including an inner rotatable bottom portion having at least a first conductive pad to provide inner angular position touch within the inner annular touch region; and an outer rotary position mechanism, the outer rotary position mechanism including an outer rotatable bottom portion having at least a second conductive pad to provide outer angular position touch within the outer annular touch region.

Example 24: The apparatus according to any of Examples 17 through 23, wherein the touch controller includes input/output (I/O) interface circuitry for coupling to a host controller, and wherein: the touch controller and/or the host controller is to: assign functions to the virtual rotary control widget that are context-sensitive, context-dependent, and/or application-dependent.

While the disclosure has been described herein with respect to certain illustrated examples, those of ordinary skill in the art will recognize and appreciate that the disclosure is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus comprising:
a touch sensor having a virtual rotary control widget, the virtual rotary control widget associated with multiple concentric annular touch regions on a touch surface of the touch sensor, the multiple concentric annular touch regions including an inner annular touch region and an outer annular touch region, the inner annular touch region concentric with the outer annular touch region, the inner annular touch region associated with inner angular position touch detection and response by the touch sensor, the outer annular touch region associated with outer angular position touch detection and response by the touch sensor.

2. The apparatus of claim 1, wherein the virtual rotary control widget is associated with an annular isolation region between and adjacent the inner annular touch region and the outer annular touch region, the annular isolation region without position touch detection and/or response by the touch sensor.

3. The apparatus of claim 1, comprising:
a non-conductive annular finger guide, the non-conductive annular finger guide to attach over an annular region substantially between the inner annular touch region and the outer annular touch region.

4. The apparatus of claim 3, comprising:
one or more additional non-conductive annular finger guides, the one or more additional non-conductive annular finger guides around an inner perimeter of the inner annular touch region, an outer perimeter of the outer annular touch region, or both the inner perimeter and the outer perimeter.

5. The apparatus of claim 1, comprising:
an inner recessed finger-guiding track substantially within the inner annular touch region; and
an outer recessed finger-guiding track substantially within the outer annular touch region.

6. The apparatus of claim 1, comprising:
a touch controller of the touch sensor, the touch controller including one or more processors and processor-executable instructions to implement the virtual rotary control widget of the touch sensor, the touch controller to provide the inner angular position touch detection and response related to the inner annular touch region, the touch controller to provide the outer angular position touch detection and response related to the outer annular touch region.

7. The apparatus of claim 1, comprising:
a rotary knob, the rotary knob to mount on the touch surface of the touch sensor over the multiple concentric annular touch regions of the virtual rotary control widget, the rotary knob including:
an inner rotary position mechanism, the inner rotary position mechanism including an inner rotatable bottom portion having at least a first conductive pad to provide inner angular position touch within the inner annular touch region; and
an outer rotary position mechanism, the outer rotary position mechanism including an outer rotatable bottom portion having at least a second conductive pad to provide outer angular position touch within the outer annular touch region.

8. A method comprising:
receiving capacitive measurement signals from a touch sensor;
detecting touch position of a touch signal at a touch surface of the touch sensor at least partially based on the capacitive measurement signals;
at least partially responsive to the detected touch position to be within an inner annular touch region of a virtual rotary control widget of the touch sensor, determining an inner angular position corresponding to the detected touch position within the inner annular touch region; and
at least partially responsive to the detected touch position to be within an outer annular touch region of the virtual rotary control widget of the touch sensor, determining an outer angular position corresponding to the detected touch position within the outer annular touch region, the inner annular touch region concentric with the outer annular touch region.

9. The method of claim 8, comprising:
at least partially responsive to the detected touch position to be within the inner annular touch region, communicating the inner angular position to a host controller; and
at least partially responsive to the detected touch position to be within the outer annular touch region, communicating the outer angular position to the host controller.

10. The method of claim 8, comprising:
at least partially responsive to the detected touch position to be within substantially a center of the virtual rotary control widget, switching between multiple modes of the virtual rotary control widget, the multiple modes including an independent control mode and an interlocked control mode.

11. The method of claim 8, wherein the virtual rotary control widget includes an independent control mode in which each said determining is performed independently responsive to the detected touch position, the virtual rotary control widget further including an interlocked control mode comprising:
at least partially responsive to the detected touch position to be within the inner annular touch region, identifying a corresponding outer angular position corresponding to the inner angular position within the inner annular touch region; and
at least partially responsive to the detected touch position to be within the outer annular touch region, identifying a corresponding inner angular position corresponding to the outer angular position within the outer annular touch region.

12. The method of claim 11, comprising:
at least partially responsive to the detected touch position to be within the inner annular touch region, communicating the inner angular position and the corresponding outer angular position to a host controller; and
at least partially responsive to the detected touch position to be within the outer annular touch region, communicating the outer angular position and the corresponding inner angular position to the host controller.

13. The method of claim 8, comprising:
at least partially responsive to the detected touch position to be within an identified one of a number of inner predefined arc regions of the inner annular touch region, selecting one of a number of inner angular positions corresponding to the identified one of the number of inner predefined arc regions, the number of inner angular positions respectively associated with the number of inner predefined arc regions and indicating respective discrete angular positions around the inner annular touch region; and
at least partially responsive to the detected touch position to be within an identified one of a number of outer predefined arc regions of the outer annular touch region, selecting one of a number of outer angular positions corresponding to the identified one of the number of outer predefined arc regions, the number of outer angular positions respectively associated with the number of outer predefined arc regions and indicating respective discrete angular positions around the outer annular touch region.

14. The method of claim 13, wherein the virtual rotary control widget includes an independent control mode in which each said selecting is performed independently responsive to the detected touch position, the virtual rotary control widget further including an interlocked control mode comprising:
at least partially responsive to the detected touch position to be within the identified one of the number of inner predefined arc regions of the inner annular touch region, selecting a corresponding one of the number of outer angular positions corresponding to the selected one of the number of inner angular positions; and
at least partially responsive to the detected touch position to be within the identified one of the number of outer predefined arc regions of the outer annular touch region, selecting a corresponding one of the number of inner angular positions corresponding to the selected one of the number of outer angular positions.

15. The method of claim 8, wherein the method is performed by a touch controller of the touch sensor to implement the virtual rotary control widget.

16. The method of claim 8, wherein the method is performed by one or more processors executing processor-executable instructions stored on a non-transitory processor-readable medium.

17. An apparatus comprising:
a capacitive touch system including:
a touch sensor;
a touch controller of the touch sensor;
a virtual rotary control widget implemented at the touch sensor in cooperation with the touch controller, the virtual rotary control widget associated with multiple concentric annular touch regions on a touch surface of the touch sensor, the multiple concentric annular touch regions including an inner annular touch region and an outer annular touch region, the inner annular touch region concentric with the outer annular touch region; and
the touch controller to:
receive capacitive measurement signals from the touch sensor;
detect touch position of a touch signal at a touch surface of the touch sensor at least partially based on the capacitive measurement signals;
at least partially responsive to the detected touch position to be within the inner annular touch region, determine an inner angular position corresponding to the detected touch position within the inner annular touch region; and
at least partially responsive to the detected touch position to be within the outer annular touch region, determine an outer angular position corresponding to the detected touch position within the outer annular touch region.

18. The apparatus of claim 17, wherein the virtual rotary control widget is associated with an annular isolation region between and adjacent the inner annular touch region and the outer annular touch region, the annular isolation region without position touch detection and/or response by the touch sensor.

19. The apparatus of claim 17, comprising:
a non-conductive annular finger guide, the non-conductive annular finger guide to attach over an annular region substantially between the inner annular touch region and the outer annular touch region.

20. The apparatus of claim 17, wherein the touch controller includes input/output (I/O) interface circuitry for coupling to a host controller, and wherein:
the touch controller is to:
communicate, to the host controller, the inner angular position at least partially responsive to the detected touch position to be within the inner annular touch region; and
communicate, to the host controller, the outer angular position at least partially responsive to the detected touch position to be within the outer annular touch region.

21. The apparatus of claim 17, wherein:
the touch controller is to:
at least partially responsive to the detected touch position to be within substantially a center of the virtual rotary control widget, switching between multiple modes of the virtual rotary control widget, the multiple modes including an independent control mode and an interlocked control mode.

22. The apparatus of claim 17, wherein the virtual rotary control widget includes an independent control mode in which the touch controller is to determine the inner angular position and determine the outer angular position independently in response to the detected touch position, the virtual rotary control widget further including an interlocked control mode, and wherein:
the touch controller is to, in the interlocked control mode:
at least partially responsive to the detected touch position to be within the inner annular touch region, identify a corresponding outer angular position corresponding to the inner angular position within the inner annular touch region; and
at least partially responsive to the detected touch position to be within the outer annular touch region, identify a corresponding inner angular position corresponding to the outer angular position within the outer annular touch region.

23. The apparatus of claim 17, comprising:
a rotary knob, the rotary knob to mount on the touch surface of the touch sensor over the multiple concentric annular touch regions of the virtual rotary control widget, the rotary knob including:
an inner rotary position mechanism, the inner rotary position mechanism including an inner rotatable bottom portion having at least a first conductive pad to provide inner angular position touch within the inner annular touch region; and
an outer rotary position mechanism, the outer rotary position mechanism including an outer rotatable bottom portion having at least a second conductive pad to provide outer angular position touch within the outer annular touch region.

24. The apparatus of claim 17, wherein the touch controller includes input/output (I/O) interface circuitry for coupling to a host controller, and wherein:
the touch controller and/or the host controller to:
assign functions to the virtual rotary control widget that are context-sensitive, context-dependent, and/or application-dependent.
